(19) United States
(12) Patent Application Publication
(10) Pub. No.: US 2024/0085692 A1
(43) Pub. Date: Mar. 14, 2024

(54) LIGHT SCANNING APPARATUS

(71) Applicant: CANON KABUSHIKI KAISHA, Tokyo (JP)

(72) Inventors: MASAYASU TERAMURA, Tochigi (JP); SOYA SAIJO, Tochigi (JP)

(21) Appl. No.: 18/464,860

(22) Filed: Sep. 11, 2023

(30) Foreign Application Priority Data
Sep. 13, 2022 (JP) 2022-145123

(51) Int. Cl. G02B 26/12

(52) U.S. Cl. CPC G02B 26/125

(57) ABSTRACT

The apparatus invention includes a deflecting unit configured to deflect first and second light fluxes to scan first and second surfaces in a main scanning direction, and first and second optical systems configured to guide the first and second light fluxes deflected by the deflecting unit to the first and second surfaces. The first optical system includes a first optical element, and a second optical element arranged between the first optical element and the first surface on an optical path of the first optical system. The second optical system includes a third optical element.

### BACKGROUND

### Technical Field

The aspect of the embodiment is related to a light scanning apparatus, and in particular, to a light scanning apparatus suitable for an image forming apparatus such as a laser beam printer (LBP), a digital copying machine or a multi-function printer (MFP).

### Description of the Related Art

In recent years, there has been a demand for reducing a size of a light scanning apparatus including a plurality of imaging optical systems mounted on a color image forming apparatus in order to reduce a size of the color image forming apparatus.

When an attempt is made to reduce the size of the light scanning apparatus including the plurality of imaging optical systems, an arrangement space of the plurality of imaging optical systems in the light scanning apparatus is reduced, so that it is necessary to pay attention to an interference between imaging optical elements included in the plurality of imaging optical systems.

Japanese Patent Application Laid-Open No. 2010-072049 discloses a light scanning apparatus in which an arrangement of imaging optical elements in a plurality of imaging optical systems is made differently from each other to reduce the size with suppressing the interference between the imaging optical elements included in the plurality of imaging optical systems.

In the light scanning apparatus disclosed Japanese Patent Application Laid-Open No. 2010-072049, the imaging optical element arranged closer to a deflecting unit in an optical path among two imaging optical elements provided in each of the plurality of imaging optical systems have the same shape.

Accordingly, since a degree of freedom in the arrangement of the imaging optical elements in each of the plurality of imaging optical systems is low, it is difficult to sufficiently reduce the size of the light scanning apparatus.

### SUMMARY

The apparatus includes a deflecting unit configured to deflect a first light flux to scan a first surface in a main scanning direction and a second light flux to scan a second surface in the main scanning direction, a first optical system configured to guide the first light flux deflected by the deflecting unit to the first surface, and a second optical system configured to guide the second light flux deflected by the deflecting unit to the second surface. The first optical system includes a first optical element, and a second optical element arranged between the first optical element and the first surface on an optical path of the first optical system. The second optical system includes a third optical element. The apparatus satisfies the following inequalities:

ϕ1≠ϕ3

ϕ2/ϕ1≤1
where ϕ1, ϕ2 and ϕ3 represent powers in a sub-scanning cross section of the first, second and third optical elements, respectively.

Further features of the disclosure will become apparent from the following description of exemplary embodiments with reference to the attached drawings.

### BRIEF DESCRIPTION OF THE DRAWINGS

FIG. 1A is a developed view in a main scanning cross section of a part of a light scanning apparatus according to a first embodiment of the present invention.

FIG. 1B is a developed view in the main scanning cross section of a part of the light scanning apparatus according to the first embodiment.

FIG. 2A is a developed view in a sub-scanning cross section of a part of the light scanning apparatus according to the first embodiment.

FIG. 2B is a sub-scanning cross sectional view of the part of the light scanning apparatus according to the first embodiment.

FIG. 3A is a developed view in the main scanning cross section of a part of a light scanning apparatus according to a second embodiment of the present invention.

FIG. 3B is a developed view in the main scanning cross section of a part of the light scanning apparatus according to the second embodiment.

FIG. 4A is a developed view in a sub-scanning cross section of a part of the light scanning apparatus according to the second embodiment.

FIG. 4B is a sub-scanning cross sectional view of the part of the light scanning apparatus according to the second embodiment.

FIG. 5A is a view showing a refractive power arrangement in a first scanning optical system in the light scanning apparatus according to the second embodiment.

FIG. 5B is a view showing the refractive power arrangement in a second scanning optical system in the light scanning apparatus according to the second embodiment.

FIG. 6A is a developed view in the sub-scanning cross section of a part of a light scanning apparatus according to a third embodiment of the present invention.

FIG. 6B is a developed view in the sub-scanning cross section of a part of the light scanning apparatus according to the third embodiment.

FIG. 6C is a sub-scanning cross sectional view of a part of the light scanning apparatus according to the third embodiment.

FIG. 7 is a sub-scanning cross sectional view of a main part of a color image forming apparatus according to the present invention.

### DESCRIPTION OF THE EMBODIMENTS

Hereinafter, a light scanning apparatus according to the present invention is described in detail with reference to accompanying drawings. Note that the drawings described below may be drawn on a scale different from an actual scale in order to facilitate understanding of the present invention.

In the following description, a main scanning direction is a direction perpendicular to a rotation axis of a deflecting unit and an optical axis of an optical system. A sub-scanning direction is a direction parallel to the rotation axis of the deflecting unit. A main scanning cross section is a section perpendicular to the sub-scanning direction. A sub-scanning cross section is a section perpendicular to the main scanning direction.

Accordingly, in the following description, it should be noted that the main scanning direction and the sub-scanning cross section are different between an incident optical system and an imaging optical system.

### First Embodiment

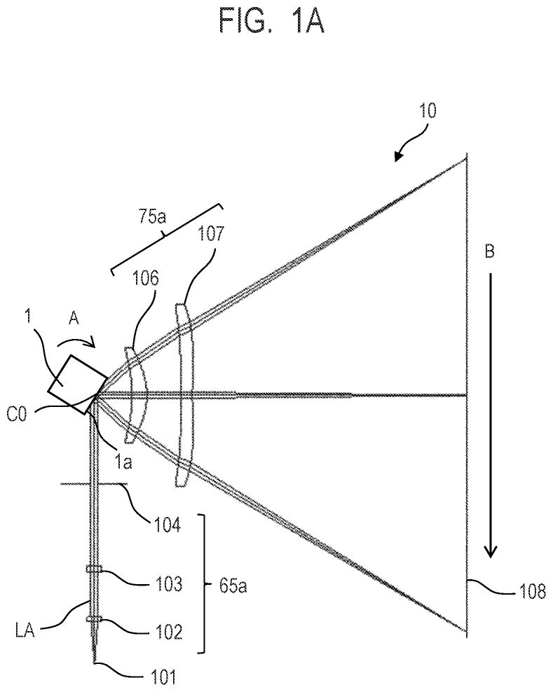

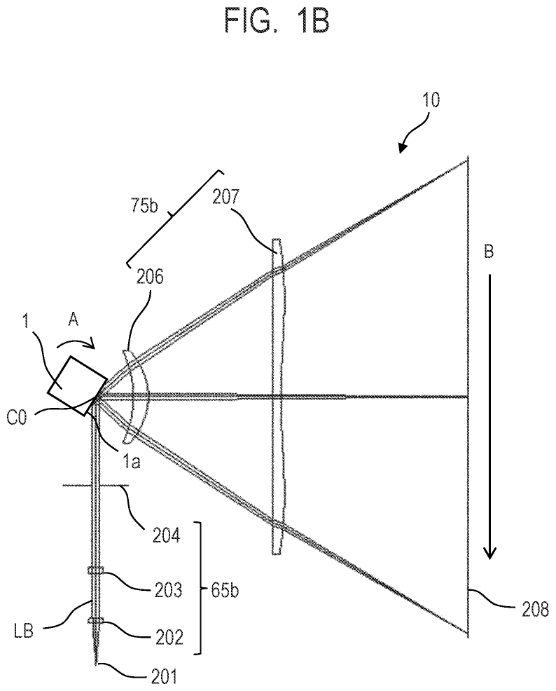

FIGS. 1A and 1B show a developed view in the main scanning cross section of a part of a light scanning apparatus 10 according to a first embodiment of the present invention, respectively.

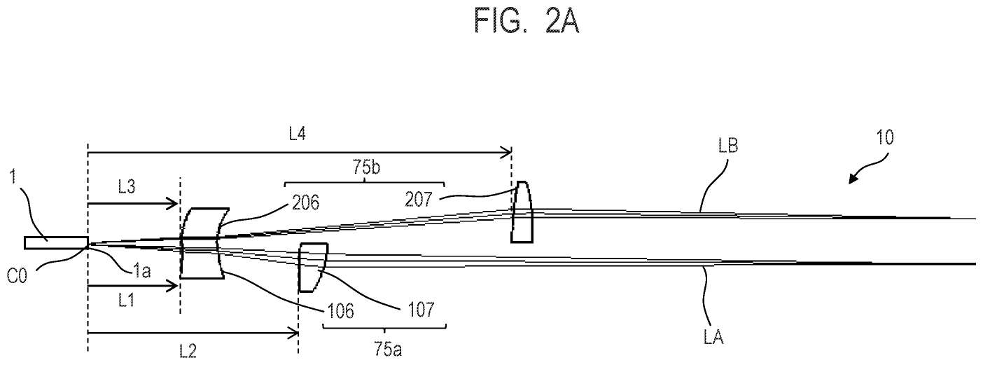

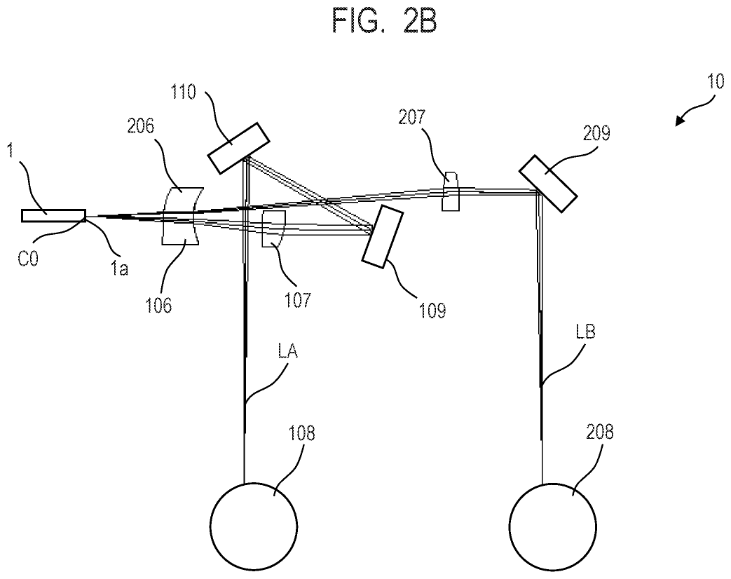

Further, FIGS. 2A and 2B show a developed view in the sub-scanning cross section and a sub-scanning cross sectional view of first and second scanning optical systems 75a and 75b included in the light scanning apparatus 10 according to the present embodiment, respectively.

The light scanning apparatus 10 according to the present embodiment includes first and second light sources 101 and 201, first and second collimating lenses 102 and 202, first and second cylindrical lenses 103 and 203, and first and second aperture stops 104 and 204.

Further, the light scanning apparatus 10 according to the present embodiment includes a deflecting unit 1, first fθ lenses 106 and 206, and second fθ lenses 107 and 207.

The second fθ lens 107 (a second imaging optical element) is arranged between the first fθ lens 106 (a first imaging optical element) and a first scanned surface 108 on an optical path. Further, the second fθ lens 207 (a fourth imaging optical element) is arranged between the first fθ lens 206 (a third imaging optical element) and a second scanned surface 208 on an optical path.

As the first and second light sources 101 and 201, semiconductor lasers or the like are used.

The first and second collimating lenses 102 and 202 convert light fluxes LA and LB emitted from the first and second light sources 101 and 201 into parallel light fluxes. Note that the parallel light flux includes not only a strictly parallel light flux but also a substantially parallel light flux such as a weakly divergent light flux or a weakly convergent light flux.

The first and second cylindrical lenses 103 and 203 have a finite power (a refractive power) in the sub-scanning cross section, and condense the light fluxes LA and LB that have passed through the first and second collimating lenses 102 and 202 in the sub-scanning direction.

The first and second aperture stops 104 and 204 limit diameters of the light fluxes LA and LB that have passed through the first and second cylindrical lenses 103 and 203.

In this way, the light fluxes LA and LB emitted from the first and second light sources 101 and 201 are condensed only in the sub-scanning direction in the vicinity of a deflecting surface 1a of the deflecting unit 1, and are imaged as line images elongated in the main scanning direction.

The deflecting unit 1 is rotated in a direction of an arrow A by a driving unit such as a motor (not shown) to deflect the incident light fluxes LA and LB. The deflecting unit 1 is formed by a polygon mirror, for example.

The first fθ lens 106 and the second fθ lens 107 are anamorphic imaging lenses having different refractive powers between the main scanning cross section and the sub-scanning cross section, and condense (guide) the light flux LA deflected by the deflecting surface 1a of the deflecting unit 1 onto the first scanned surface 108.

The first fθ lens 206 and the second fθ lens 207 are anamorphic imaging lenses having different refractive powers between the main scanning cross section and the sub-scanning cross section, and condense (guide) the light flux LB deflected by the deflecting surface 1a of the deflecting unit 1 onto the second scanned surface 208.

In the light scanning apparatus 10 according to the present embodiment, the first collimating lens 102, the first cylindrical lens 103 and the first aperture stop 104 form a first incident optical system 65a. The second collimating lens 202, the second cylindrical lens 203 and the second aperture stop 204 form a second incident optical system 65b.

Further, in the light scanning apparatus 10 according to the present embodiment, the first fθ lens 106 and the second fθ lens 107 form a first scanning optical system 75a (a first imaging optical system). The first fθ lens 206 and the second fθ lens 207 form a second scanning optical system 75b (a second imaging optical system).

Note that the refractive powers in the sub-scanning cross section of the second fθ lenses 107 and 207 are stronger than those of the first fθ lenses 106 and 206, namely the strongest in the first and second scanning optical systems 75a and 75b, respectively.

The light flux LA (a first light flux) emitted from a light emitting point of the first light source 101 is converted into a parallel light flux by the first collimating lens 102.

The converted light flux is condensed in the sub-scanning direction by the first cylindrical lens 103, passes through the first aperture stop 104, and is incident on the deflecting surface 1a of the deflecting unit 1.

The light flux LA emitted from the first light source 101 and incident on the deflecting surface 1a of the deflecting unit 1 is deflected for scanning by the deflecting unit 1, and then condensed on the first scanned surface 108 by the first scanning optical system 75a to scan the first scanned surface 108 at a constant speed.

Further, the light flux LB (a second light flux) emitted from a light-emitting point of the second light source 201 is converted into a parallel light flux by the second collimating lens 202.

The converted light flux LB is condensed in the sub-scanning direction by the second cylindrical lens 203, passes through the second aperture stop 204, and is incident on the deflecting surface 1a of the deflecting unit 1.

The light flux LB emitted from the second light source 201 and incident on the deflecting surface 1a of the deflecting unit 1 is deflected for scanning by the deflecting unit 1, and then condensed on the second scanned surface 208 by the second scanning optical system 75b to scan the second scanned surface 208 at a constant speed.

Since the deflecting unit 1 rotates in the direction of the arrow A, the deflected light fluxes LA and LB scan the first and second scanned surfaces 108 and 208 in a direction of an arrow B, respectively.

Further, C0 is a deflection point (an on-axis deflection point) on the deflecting surface 1a of the deflecting unit 1 with respect to principal rays of the light fluxes LA and LB (hereinafter referred to as on-axis light fluxes) for scanning on-axis image heights of the first and second scanned surfaces 108 and 208. The on-axis deflection point C0 is a reference point (a deflection reference point) of the first and second scanning optical systems 75a and 75b.

In the present embodiment, first and second photosensitive drums 108 and 208 are used as the first and second scanned surfaces 108 and 208.

An exposure distribution in the sub-scanning direction on the first and second photosensitive drums 108 and 208 is formed by rotating the first and second photosensitive drums 108 and 208 in the sub-scanning direction for each main scanning exposure.

In the light scanning apparatus 10 according to the present embodiment, the first fθ lens 106 provided in the first scanning optical system 75a and the first fθ lens 206 provided in the second scanning optical system 75b are an optical element formed integrally with each other.

This makes it possible to reduce the size of the light scanning apparatus 10 according to the present embodiment.

Further, the light scanning apparatus 10 according to the present embodiment employs a structure in which the light flux LA that has passed through the first incident optical system 65a and the light flux LB that has passed through the second incident optical system 65b are obliquely incident on the deflecting surface 1a of the deflecting unit 1 in the sub-scanning cross section.

This makes it possible to further reduce the size of the light scanning apparatus 10 according to the present embodiment.

Tables 1 to 3 show various characteristics of the first and second incident optical systems 65a and 65b and the first and second scanning optical systems 75a and 75b of the light scanning apparatus 10 according to the present embodiment.

TABLE 1
Characteristics of light sources 101 and 201

| | | |
|---|---|---|
| Wavelength | λ(nm) | 790 |
| Incident polarization to deflecting | | p-polarization |
| surface 1a of deflecting unit 1 | | |
| Full angle at half maximum in main | FFPy(deg) | 12.00 |
| scanning direction | | |
| Full angle at half maximum in the | FFPz(deg) | 30.00 |
| sub-scanning direction | | |

Shape of stops

| | Main scanning direction | Sub-scanning direction |
|---|---|---|
| Aperture stop 104 | 3.050 | 1.700 |
| Aperture stop 204 | 3.050 | 0.782 |

Refractive Index

| | | |
|---|---|---|
| Collimating lenses 102 and 202 | N1 | 1.5240 |
| Cylindrical lenses 103 and 203 | N2 | 1.5240 |

| | |
|---|---|
| Main scanning | Sub-scanning |
| direction | direction |

Shape of optical elements

| | | | |
|---|---|---|---|
| Curvature radius of incident | r1a | ∞ | ∞ |
| surface of collimating lenses | (mm) | | |
| 102 and 202 | | | |
| Curvature radius of exit | r1b | −15.216 | −15.216 |
| surface of collimating lenses | (mm) | | |
| 102 and 202 | | | |
| Curvature radius of incident | r2a | ∞ | 41.028 |
| surface of cylindrical lenses | (mm) | | |
| 103 and 203 | | | |
| Curvature radius of exit | r2b | ∞ | ∞ |
| surface of cylindrical | (mm) | | |
| lenses 103 and 203 | | | |

Focal length

| | | | |
|---|---|---|---|
| Collimating lenses 102 | fcol | 19.31 | 19.31 |
| and 202 | (mm) | | |
| Cylindrical lenses 103 | fcyl | ∞ | 77.71 |
| and 203 | (mm) | | |

Arrangement

| | | |
|---|---|---|
| From light sources 101 and 201 to incident | d0 (mm) | 18.79 |
| surface of collimating lenses 102 and 202 | | |
| From incident surface of collimating lenses | d1 (mm) | 2.40 |
| 102 and 202 to exit surface of collimating | | |
| lenses 102 and 202 | | |
| From exit surface of collimating lenses 102 | d2 (mm) | 20.06 |
| and 202 to incident surface of cylindrical | | |
| lenses 103 and 203 | | |
| From incident surface of cylindrical lenses | d3 (mm) | 3.00 |
| 103 and 203 to exit surface of cylindrical | | |
| lenses 103 and 203 | | |
| From exit surface of cylindrical lenses 103 | d4 (mm) | 36.67 |
| and 203 to aperture stop 104 and 204 | | |
| From aperture stop 104 and 204 to deflecting | d5 (mm) | 40.33 |
| surface 1a of deflecting unit 1 | | |
| Incident angle of light flux LA that has passed | A1 (deg) | 90.00 |
| through aperture stop 104 on deflecting surface | | |
| 1a in main scanning cross section | | |
| Incident angle of light flux LB that has passed | A2 (deg) | 90.00 |
| through aperture stop 204 on deflecting surface | | |
| 1a in main scanning cross section | | |
| Incident angle of light flux LA that has passed | A3 (deg) | 3.00 |
| through aperture stop 104 on deflecting surface | | |
| 1a in sub-scanning cross section | | |
| Incident angle of light flux LB that has passed | A4 (deg) | −3.00 |
| through aperture stop 204 on deflecting surface | | |
| 1a in sub-scanning cross section | | |

TABLE 2
fθ-coefficient, Scanning width, Maximum angle of view

| | | |
|---|---|---|
| fθ-coefficient | k(mm/rad) | 146 |
| Scanning width | W(mm) | 230 |
| Maximum angle of view | θ(deg) | 45.1 |

Refractive index

| | | |
|---|---|---|
| Refractive index of first fθ lens 106 | N5 | 1.5240 |
| Refractive index of second fθ lens 107 | N6 | 1.5240 |

Deflecting unit 1

| | | |
|---|---|---|
| Number of deflecting surfaces | | 4 |
| Radius of circumscribed circle | Rpol(mm) | 10 |
| From rotation center to deflection | Xpol(mm) | 5.74 |
| reference point C0 (optical axis direction) | | |
| From rotation center to deflection | Ypol(mm) | 4.26 |
| reference point C0 (main scanning direction) | | |

Arrangement of scanning optical system 75a

| | | |
|---|---|---|
| From deflection reference point C0 to | d12 (mm) | 17.00 |
| incident surface of first fθ lens 106 | | |
| From incident surface of first fθ lens | d13 (mm) | 6.70 |
| 106 to exit surface of first fθ lens 106 | | |
| From exit surface of first fθ lens 106 | d14 (mm) | 15.50 |
| to incident surface of second fθ lens 107 | | |
| From incident surface of second fθ lens | d15 (mm) | 5.00 |
| 107 to exit surface of second fθ lens 107 | | |
| From exit surface of second fθ lens 107 | d16 (mm) | 123.80 |
| to first scanned surface 108 | | |
| From deflection reference point C0 to | L1(mm) | 17.00 |
| incident surface of first fθ lens 106 | | |
| From deflection reference point C0 to | L2(mm) | 39.20 |
| incident surface of second fθ lens 107 | | |
| From deflection reference point C0 to | T1(mm) | 168.00 |
| first scanned surface 108 | | |
| Sub-scanning eccentricity of second fθ lens 107 | shiftZ(mm) | 2.577 |

Meridional line shape of first fθ lens 106

| | Incident surface | Exit surface |
|---|---|---|
| | Opposite light source side | Opposite light source side |
| R | −66.201 | −30.367 |
| ku | 7.380E−01 | −1.376E+00 |
| B4u | −3.631E−06 | 3.318E−06 |
| B6u | 1.426E−08 | −5.779E−09 |
| B8u | 0.000E+00 | 9.054E−12 |
| B10u | 0.000E+00 | 1.227E−14 |
| B12u | 0 | 0 |

| | Light source side | Light source side |
|---|---|---|
| kl | 7.380E−01 | −1.376E+00 |
| B4l | −3.631E−06 | 3.318E−06 |
| B6l | 1.426E−08 | −5.779E−09 |
| B8l | 0 | 9.054E−12 |
| B10l | 0 | 1.227E−14 |
| B12l | 0 | 0 |

Sagittal line shape of first fθ lens 106

| | Incident surface | Exit surface |
|---|---|---|
| | Change of R of sagittal line | Change of R of sagittal line |
| r | −53.456 | 17.689 |
| E2u | 0 | 2.503E−03 |
| E2l | 0 | 2.112E−03 |
| E4u | 0 | 2.26E−05 |
| E4l | 0 | 1.528E−05 |
| E6u | 0 | −3.88E−08 |
| E6l | 0 | −1.800E−08 |
| E8u | 0 | 0 |
| E8l | 0 | 0 |
| E10 | 0 | 0 |
| E10l | 0 | 0 |

| | Sagittal line tilt | Sagittal line tilt |
|---|---|---|
| M0_1 | 0 | 0 |
| M1_1 | 0 | 0 |
| M2_1 | 0 | 0 |
| M3_1 | 0 | 0 |
| M4_1 | 0 | 0 |
| M5_1 | 0 | 0 |
| M6_1 | 0 | 0 |
| M7_1 | 0 | 0 |
| M8_1 | 0 | 0 |
| M9_1 | 0 | 0 |
| M10_1 | 0 | 0 |
| M11_1 | 0 | 0 |

Meridional line shape of second fθ lens 107

| | Incident surface | Exit surface |
|---|---|---|
| | Opposite light source side | Opposite light source side |
| R | −314.1209 | 238.658 |
| ku | −474.1401 | −1.633E+02 |
| B4u | 1.6996E−07 | −3.242E−06 |
| B6u | −1.005E−09 | 1.599E−09 |
| B8u | 3.80167E−13 | −8.657E−13 |
| B10u | 0 | 2.121E−16 |
| B12u | 0 | 0 |

| | Light source side | Light source side |
|---|---|---|
| kl | −474.1401 | −1.633E+02 |
| B4l | 1.6996E−07 | −3.242E−06 |
| B6l | −1.005E−09 | 1.599E−09 |
| B8l | 3.80167E−13 | −8.657E−13 |
| B10l | 0 | 2.121E−16 |
| B12l | 0 | 0 |

Sagittal line shape of second fθ lens 107

| | Incident surface | Exit surface |
|---|---|---|
| | Change of R of sagittal line | Change of R of sagittal line |
| r | 78.394 | −14.692 |
| E2u | −6.29E−04 | 1.028E−03 |
| E2l | −1.313E−03 | 1.052E−03 |
| E4u | 1.41E−05 | −2.48E−06 |
| E4l | 1.692E−05 | −2.597E−06 |
| E6u | −3.06E−08 | 3.19E−09 |
| E6l | −4.211E−08 | 3.344E−09 |
| E8u | 7.66E−11 | −1.94E−12 |
| E8l | 7.640E−11 | −2.163E−12 |
| E10 | −5.72E−14 | 4.36E−16 |
| E10l | −3.48E−14 | 5.54E−16 |

| | Sagittal line tilt | Sagittal line tilt |
|---|---|---|
| M0_1u | 3.370E−02 | 1.760E−01 |
| M0_1l | 3.37E−02 | 1.760E−01 |
| M2_1u | −1.651E−05 | −1.321E−04 |
| M2_1l | −4.148E−05 | −1.374E−04 |
| M4_1u | 1.755E−07 | 2.273E−07 |
| M4_1l | 1.525E−07 | 1.796E−07 |
| M6_1u | −2.764E−10 | −2.006E−10 |
| M6_1l | −1.134E−10 | −6.672E−11 |
| M8_1u | 1.982E−13 | 1.087E−13 |
| M8_1l | 4.370E−14 | 1.270E−15 |
| M10_1u | −5.604E−17 | −2.743E−17 |
| M10_1l | −1.42E−17 | 1.28E−18 |

TABLE 3
fθ-coefficient, Scanning width, Maximum angle of view

| | | |
|---|---|---|
| fθ-coefficient | k(mm/rad) | 146 |
| Scanning width | W(mm) | 230 |
| Maximum angle of view | θ(deg) | 45.1 |

Refractive index

| | | |
|---|---|---|
| Refractive index of first fθ lens 206 | N5 | 1.5240 |
| Refractive index of second fθ lens 207 | N6 | 1.5240 |

Deflecting unit 1

| | | |
|---|---|---|
| Number of deflecting surfaces | | 4 |
| Radius of circumscribed circle | Rpol(mm) | 10 |
| From rotation center to deflection reference | Xpol(mm) | 5.74 |
| point C0 (optical axis direction) | | |
| From rotation center to deflection reference | Ypol(mm) | 4.26 |
| point C0 (main scanning direction) | | |

Arrangement of scanning optical system 75b

| | | |
|---|---|---|
| From deflection reference point C0 to incident | d12 (mm) | 17.00 |
| surface of first fθ lens 206 | | |
| From incident surface of first fθ lens 206 to | d13 (mm) | 6.70 |
| exit surface of first fθ lens 206 | | |
| From exit surface of first fθ lens 206 to | d14 (mm) | 56.30 |
| incident surface of second fθ lens 207 | | |
| From incident surface of second fθ lens 207 to | d15 (mm) | 3.50 |
| exit surface of second fθ lens 207 | | |
| From exit surface of second fθ lens 207 to | d16 (mm) | 84.50 |
| second scanned surface 208 | | |
| From deflection reference point C0 to incident | L3(mm) | 17.00 |
| surface of first fθ lens 206 | | |
| From deflection reference point C0 to incident | L4(mm) | 80.00 |
| surface of second fθ lens 207 | | |
| From deflection reference point C0 to second | T1(mm) | 168.00 |
| scanned surface 208 | | |
| Sub-scanning eccentricity of second fθ lens 207 | shiftZ(mm) | 5.67 |

Meridional line shape of first fθ lens 206

| | Incident surface | Exit surface |
|---|---|---|
| | Opposite light source side | Opposite light source side |
| R | −39.866 | −26.253 |
| ku | 2.065E+00 | −2.866E+00 |
| B4u | 9.292E−06 | −1.398E−05 |
| B6u | 3.110E−08 | 2.362E−08 |
| B8u | −1.025E−10 | −2.189E−11 |
| B10u | 1.310E−13 | −2.171E−14 |
| B12u | 0 | 0 |

| | Light source side | Light source side |
|---|---|---|
| kl | 2.065E+00 | −2.866E+00 |
| B4l | 9.292E−06 | −1.412E−05 |
| B6l | 3.110E−08 | 2.454E−08 |
| B8l | −1.025E−10 | −2.394E−11 |
| B10l | 1.310E−13 | −1.979E−14 |
| B12l | 0 | 0 |

Sagittal line shape of first fθ lens 206

| | Incident surface | Exit surface |
|---|---|---|
| | Change of R of sagittal line | Change of R of sagittal line |
| r | 13.000 | 11.268 |
| E1 | 0 | 1.455E−04 |
| E2 | 0 | −1.686E−04 |
| E3 | 0 | 0 |
| E4 | 0 | −4.846E−07 |
| E5 | 0 | 0 |
| E6 | 0 | 1.156E−09 |
| E7 | 0 | 0 |
| E8 | 0 | 0 |
| E9 | 0 | 0 |
| E10 | 0 | 0 |

| | Sagittal line tilt | Sagittal line tilt |
|---|---|---|
| M0_1 | 0 | 0.03844881 |
| M1_1 | 0 | −9.26608E−06 |
| M2_1 | 0 | −8.68629E−05 |
| M3_1 | 0 | 0 |
| M4_1 | 0 | 0 |
| M5_1 | 0 | 0 |
| M6_1 | 0 | 0 |
| M7_1 | 0 | 0 |
| M8_1 | 0 | 0 |
| M9_1 | 0 | 0 |
| M10_1 | 0 | 0 |
| M11_1 | 0 | 0 |

Meridional line shape of second fθ lens 207

| | Incident surface | Exit surface |
|---|---|---|
| | Opposite light source side | Opposite light source side |
| R | −10000 | 228.410 |
| ku | 0 | −5.462E+01 |
| B4u | 0 | −5.399E−07 |
| B6u | 0 | 1.054E−10 |
| B8u | 0 | −1.701E−14 |
| B10u | 0 | 1.722E−18 |
| B12u | 0 | −7.826E−23 |

| | Light source side | Light source side |
|---|---|---|
| kl | 0 | −5.462E+01 |
| B4l | 0 | −5.411E−07 |
| B6l | 0 | 1.067E−10 |
| B8l | 0 | −1.777E−14 |
| B10l | 0 | 1.890E−18 |
| B12l | 0 | −9.085E−23 |

Sagittal line shape of second fθ lens 207

| | Incident surface | Exit surface |
|---|---|---|
| | Change of R of sagittal line | Change of R of sagittal line |
| r | 60.676 | −31.725 |
| E1 | 0.00E+00 | 2.169E−04 |
| E2 | 4.470E−04 | 3.483E−05 |
| E3 | 0 | 0 |
| E4 | −4.827E−08 | 5.550E−09 |
| E5 | 0 | 0 |
| E6 | −2.372E−12 | −3.405E−12 |
| E7 | 0 | 0 |
| E8 | 2.304E−15 | 2.138E−16 |
| E9 | 0 | 0 |
| E10 | 0 | 0 |

| | Sagittal line tilt | Sagittal line tilt |
|---|---|---|
| M0_1 | 9.462E−02 | −8.550E−02 |
| M1_1 | 3.55E−04 | 3.581E−04 |
| M2_1 | 2.849E−06 | 3.393E−05 |
| M3_1 | −5.463E−08 | −7.297E−08 |
| M4_1 | 1.278E−09 | −9.985E−09 |
| M5_1 | 2.873E−12 | 1.851E−11 |
| M6_1 | −1.077E−12 | 2.695E−12 |
| M7_1 | 2.305E−15 | −1.912E−15 |
| M8_1 | −2.333E−16 | −7.635E−16 |
| M9_1 | −1.496E−19 | 2.569E−19 |
| M10_1 | 2.586E−20 | 4.568E−20 |
| M11_1 | 0 | 0 |

Here, the optical axis, an axis orthogonal to the optical axis in the main scanning cross section, and an axis orthogonal to the optical axis in the sub-scanning cross section are defined as an X-axis, a Y-axis and a Z-axis, respectively, when an intersecting point between each lens surface and the optical axis is defined as an origin. Further, “E-x” means “×10^{-x}” in Tables 2 and 3.

The aspherical surface shape in the main scanning cross section (a meridional line shape) of each lens surface of the first fθ lenses 106 and 206 and the second fθ lenses 107 and 207 of the light scanning apparatus 10 according to the present embodiment is expressed by the following equation (1):

$$X = \frac{\frac{{Y}^{2}}{R}}{1 + \sqrt{1 - ( 1 + K ) {( \frac{Y}{R} )}^{2}}} + {\sum }_{i = 4}^{12} {B}_{i} {Y}^{i} . \qquad ( 1 )$$

In the expression (1), R represents a curvature radius, K represents an eccentricity, and Bi (i=4, 6, 8, 10, 12) represents an aspherical coefficient.

Further, the aspherical surface shape in the sub-scanning cross section (a sagittal line shape) of each lens surface of the first fθ lenses 106 and 206 and the second fθ lenses 107 and 207 is expressed by the following expression (2):

$$S = \frac{\frac{{Z}^{2}}{{r}^{′}}}{1 + \sqrt{1 - {( \frac{Z}{{r}^{′}} )}^{2}}} + {\sum }_{j = 0}^{12} {\sum }_{k = 1}^{1} {M}_{j k} {Y}^{j} {Z}^{k} . \qquad ( 2 )$$

In the expression (2), Mjk (j=0 to 12, and k=1) represents an aspherical coefficient.

The curvature radius r′ in the sub-scanning cross section continuously changes according to a y coordinate of the lens surface as in the following expression (3):

$${r}^{′} = r ( 1 + {\sum }_{j = 1}^{10} {E}_{j} {Y}^{j} ) . \qquad ( 3 )$$

In the expression (3), r represents a curvature radius on the optical axis, and Ej (j=1 to 10) represents a variation coefficient.

In the expression (1), when the coefficient Bi is different between a positive side and a negative side with respect to y, a subscript u is added to the coefficient Bi on the positive side (namely, Biu), and a subscript 1 is added to the coefficient Bi on the negative side (namely, Bil) as shown in Tables 2 and 3.

The same applies to the coefficient Mjk in the expression (2) and the coefficient Ej in the expression (3).

Next, effects of the light scanning apparatus 10 according to the present embodiment are described.

As shown in FIG. 2B, reflecting mirrors 109 and 110 (first reflecting elements) are provided on the optical path of the light flux LA deflected by the deflecting unit 1, and a reflecting mirror 209 (a second reflecting element) is provided on the optical path of the light flux LB deflected by the deflecting unit 1.

As the reflecting mirrors 109, 110 and 209, reflecting elements or the like on which a vapor deposition film is formed are used.

The light flux LA that has passed through the second fθ lens 107 provided in the first scanning optical system 75a is reflected by the reflecting mirror 109 and the reflecting mirror 110 in this order, thereby is guided to the first scanned surface 108.

Further, the light flux LB that has passed through the second fθ lens 207 provided in the second scanning optical system 75b is reflected by the reflecting mirror 209, thereby is guided to the second scanned surface 208.

Here, it is considered to reduce a distance between the first and second photosensitive drums 108 and 208 corresponding to the first and second scanned surfaces 108 and 208 in order to reduce a size of an image forming apparatus in which the light scanning apparatus 10 according to the present embodiment is mounted.

At this time, if the second fθ lens 107 and the second fθ lens 207 are arranged at positions away from the deflecting unit 1 by a distance optically equivalent to each other in the light scanning apparatus 10 according to the present embodiment, an unnecessary interference of the light flux with the second fθ lens may occur.

Specifically, the light flux LA may be incident on the second fθ lens 207 provided in the second scanning optical system 75b, or the light flux LB may be incident on the second fθ lens 107 provided in the first scanning optical system 75a.

Accordingly, in the light scanning apparatus 10 according to the present embodiment, the second fθ lens 107 and the second fθ lens 207 are arranged at positions away from the deflecting unit 1 by a distance optically non-equivalent to each other. Specifically, the second fθ lens 107 is arranged at a position closer to the deflecting unit 1 than the second fθ lens 207 on an optical path.

This makes it possible to reduce the distance between the first and second photosensitive drums 108 and 208 while suppressing the unnecessary interference of the light flux with the second fθ lens to achieve a reduction in the size of the image forming apparatus in which the light scanning apparatus 10 according to the present embodiment is mounted.

Table 4 shows various characteristics of the first fθ lenses 106 and 206 and the second fθ lenses 107 and 207 provided in the light scanning apparatus 10 according to the present embodiment.

TABLE 4

| | Incident surface | Exit surface | Entire system |
|---|---|---|---|
| | First fθ lens 106 | | |
| Refractive Index | 1.524 | | |
| Thickness | 6.7 | | |
| Curvature radius | −53.456 | 17.689 | — |
| Refractive power | −0.0098 | −0.0296 | −0.0407 |
| Tilt amount (M0_1) | 0 | 0.0000 | — |
| Focal length | −102.016 | −33.757 | −24.568 |
| | First fθ lens 206 | | |
| Refractive Index | 1.524 | | |
| Thickness | 6.7 | | |
| Curvature radius | 13 | 11.268 | — |
| Refractive power | 0.0403 | −0.0465 | 0.0020 |
| Tilt amount (M0_1) | 0 | 0.0384 | — |
| Focal length | 24.809 | −21.503 | 489.233 |
| | Second fθ lens 107 | | |
| Refractive Index | 1.524 | | |
| Thickness | 5.0 | | |
| Curvature radius | 78.394 | −14.692 | — |
| Refractive power | 0.0067 | 0.0357 | 0.0416 |
| Tilt amount (M0_1) | 0.034 | 0.1760 | — |
| Focal length | 149.608 | 28.038 | 24.057 |
| | Second fθ lens 207 | | |
| Refractive Index | 1.524 | | |
| Thickness | 3.5 | | |
| Curvature radius | 60.676 | −31.725 | — |
| Refractive power | 0.0086 | 0.0165 | 0.0248 |
| Tilt amount (M0_1) | 0.095 | −0.0855 | — |
| Focal length | 115.795 | 60.543 | 40.281 |

Here, refractive powers in the sub-scanning cross section of the first and second fθ lenses 106 and 107 are represented by ϕ1 and ϕ2, respectively.

Further, the refractive powers in the sub-scanning cross section of the first and second fθ lenses 206 and 207 are represented by ϕ3 and ϕ4, respectively.

At this time, in the light scanning apparatus 10 according to the present embodiment, the following inequalities (4) and (5) are satisfied:

ϕ2/ϕ1≤1 (4)

ϕ1≠ϕ3 (5).

Specifically, ϕ1=−0.0407, ϕ2=0.0416 and ϕ3=0.0020 as shown in Table 4 in the light scanning apparatus 10 according to the present embodiment, so that the inequalities (4) and (5) are satisfied.

In the light scanning apparatus 10 according to the present embodiment, the refractive power in the sub-scanning cross section of each of the first fθ lenses 106 and 206 and the second fθ lens 107 is set so as to satisfy the inequalities (4) and (5).

Thereby, the first and second scanning optical systems 75a and 75b can adopt the optical arrangement as shown in FIGS. 2A and 2B, and the light scanning apparatus 10 according to the present embodiment and the image forming apparatus on which the light scanning apparatus 10 according to the present embodiment is mounted can be downsized.

Further, in the light scanning apparatus 10 according to the present embodiment, the following inequality (6) is satisfied:

ϕ3≤ϕ4 (6).

Specifically, in the light scanning apparatus 10 according to the present embodiment, ϕ3=0.0020 and ϕ4=0.0248 as shown in Table 4, so that the inequality (6) is satisfied.

Thereby, it is possible to suppress an interference of the light flux LA with the second fθ lens 207 by arranging the second fθ lens 207 at a position away from the deflecting unit 1.

As described above, in the light scanning apparatus 10 according to the present embodiment, it is possible to achieve a sufficient reduction in the size by forming the first and second scanning optical systems 75a and 75b such that the inequalities (4) and (5) are satisfied.

In the light scanning apparatus 10 according to the present embodiment, a diffractive optical element may be used instead of at least one of the first fθ lenses 106 and 206 and the second fθ lenses 107 and 207. In this case, a diffractive power of the diffractive optical element may satisfy the above-described inequalities (4) and (5).

In the light scanning apparatus 10 according to the present embodiment, the refractive powers of the first fθ lenses 106 and 206 and the second fθ lenses 107 and 207 and the diffractive power of the diffractive optical element are collectively referred to as powers.

### Second Embodiment

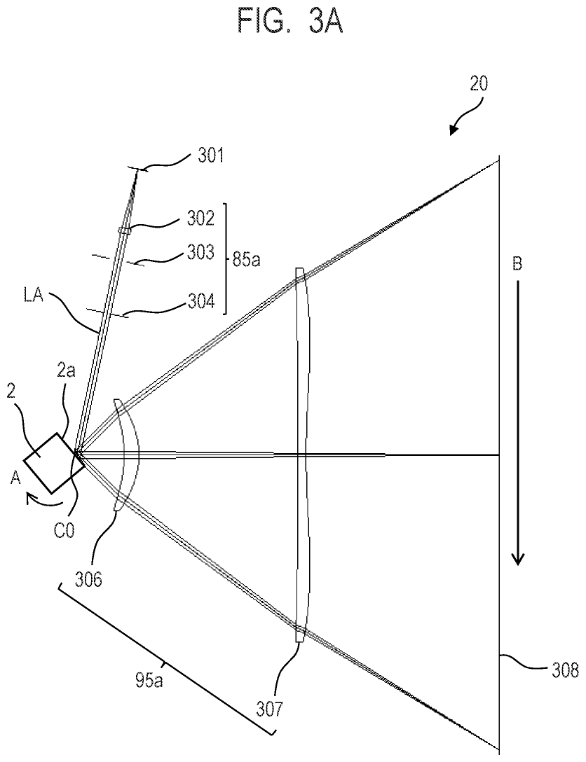

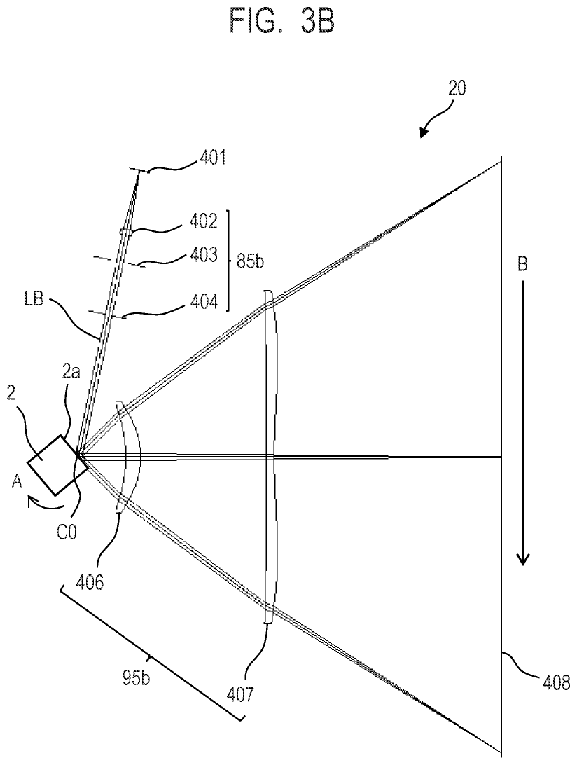

FIGS. 3A and 3B show a developed view in the main scanning cross section of a part of a light scanning apparatus 20 according to a second embodiment of the present invention, respectively.

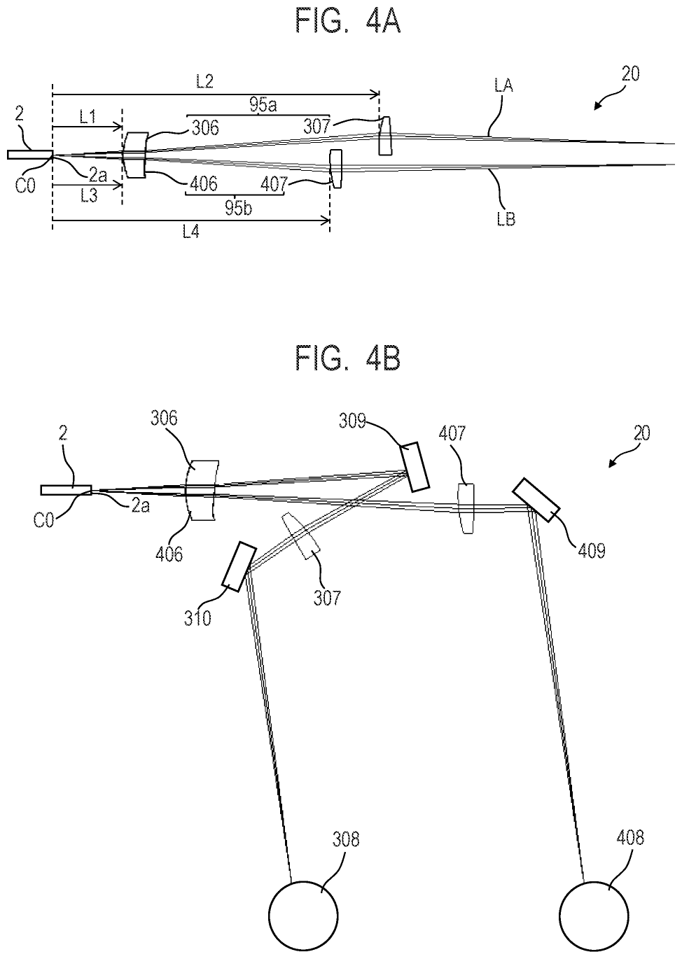

Further, FIGS. 4A and 4B show a developed view in the sub-scanning cross section and a sub-scanning cross sectional view of the first and second scanning optical systems 95a and 95b included in the light scanning apparatus 20 according to the present embodiment, respectively.

The light scanning apparatus 20 according to the present embodiment includes first and second light sources 301 and 401, first and second anamorphic collimating lenses 302 and 402, first and second sub-scanning stops 303 and 403, and first and second main scanning stops 304 and 404.

Further, the light scanning apparatus 20 according to the present embodiment includes a deflecting unit 2, first fθ lenses 306 and 406, and second fθ lenses 307 and 407.

The second fθ lens 307 (a second imaging optical element) is arranged between the first fθ lens 306 (a first imaging optical element) and the first scanned surface 308 on an optical path. Further, the second fθ lens 407 (a fourth imaging optical element) is arranged between the first fθ lens 406 (a third imaging optical element) and the second scanned surface 408 on an optical path.

As the first and second light sources 301 and 401, semiconductor lasers or the like are used.

The first and second anamorphic collimating lenses 302 and 402 convert the light fluxes LA and LB emitted from the first and second light sources 301 and 401 into parallel light fluxes in the main scanning cross section, and condense the light fluxes in the sub-scanning direction. Note that the parallel light flux includes not only a strictly parallel light flux but also a substantially parallel light flux such as a weakly divergent light flux or a weakly convergent light flux.

The first and second sub-scanning stops 303 and 403 limit light flux diameters in the sub-scanning direction of the light fluxes LA and LB that have passed through the first and second anamorphic collimating lenses 302 and 402.

The first and second main scanning stops 304 and 404 limit the light flux diameters in the main scanning direction of the light fluxes LA and LB that have passed through the first and second sub-scanning stops 303 and 403.

In this way, the light fluxes LB and LB emitted from the first and second light sources 301 and 401 are condensed only in the sub-scanning direction in the vicinity of a deflecting surface 2a of the deflecting unit 2, and are imaged as line images elongated in the main scanning direction.

The deflecting unit 2 is rotated in a direction of an arrow A by a driving unit such as a motor (not shown) to deflect the incident light fluxes LA and LB. The deflecting unit 2 is formed by a polygon mirror, for example.

The first fθ lens 306 and the second fθ lens 307 are anamorphic imaging lenses having different refractive powers between the main scanning cross section and the sub-scanning cross section, and condense (guide) the light flux LA deflected by the deflecting surface 2a of the deflecting unit 2 onto the first scanned surface 308.

The first fθ lens 406 and the second fθ lens 407 are anamorphic imaging lenses having different refractive powers between the main scanning cross section and the sub-scanning cross section, and condense (guide) the light flux LB deflected by the deflecting surface 2a of the deflecting unit 2 onto the second scanned surface 408.

In the light scanning apparatus 20 according to the present embodiment, the first anamorphic collimating lens 302, the first sub-scanning stop 303 and the first main scanning stop 304 form a first incident optical system 85a. The second anamorphic collimating lens 402, the second sub-scanning stop 403 and the second main scanning stop 404 form a second incident optical system 85b.

Further, in the light scanning apparatus 20 according to the present embodiment, the first fθ lens 306 and the second fθ lens 307 form a first scanning optical system 95a (a first imaging optical system). The first fθ lens 406 and the second fθ lens 407 form a second scanning optical system 95b (a second imaging optical system).

Note that refractive powers in the sub-scanning cross section of the second fθ lenses 307 and 407 are stronger than those of the first fθ lenses 306 and 406, namely the strongest in the first and second scanning optical systems 95a and 95b, respectively.

The light flux LA emitted from a light emitting point of the first light source 301 is converted into a parallel light flux, and is condensed in the sub-scanning direction by the first anamorphic collimating lens 302.

The converted and condensed light flux LA passes through the first sub-scanning stop 303 and the first main scanning stop 304, and then is incident on the deflecting surface 2a of the deflecting unit 2.

The light flux LA emitted from the first light source 301 and incident on the deflecting surface 2a of the deflecting unit 2 is deflected for scanning by the deflecting unit 2, and then condensed on the first scanned surface 308 by the first scanning optical system 95a to scan the first scanned surface 308 at a constant speed.

The light flux LB emitted from a light emitting point of the second light source 401 is converted into a parallel light flux, and is condensed in the sub-scanning direction by the second anamorphic collimating lens 402.

The converted and condensed light flux LB passes through the second sub-scanning stop 403 and the second main scanning stop 404, and then is incident on the deflecting surface 2a of the deflecting unit 2.

The light flux LB emitted from the second light source 401 and incident on the deflecting surface 2a of the deflecting unit 2 is deflected for scanning by the deflecting unit 2, and then condensed on the second scanned surface 408 by the second scanning optical system 95b to scan the second scanned surface 408 at a constant speed.

Since the deflecting unit 2 rotates in the direction of the arrow A, the deflected light fluxes LA and LB scan the first and second scanned surfaces 308 and 408 in a direction of an arrow B, respectively.

C0 is a deflection point (an on-axis deflection point) on the deflecting surface 2a of the deflecting unit 2 with respect to principal rays of on-axis light fluxes of the light fluxes LA and LB, and is a reference point (a deflection reference point) of the first and second scanning optical systems 95a and 95b.

In the present embodiment, the first and second photosensitive drums 308 and 408 are used as the first and second scanned surfaces 308 and 408.

An exposure distribution in the sub-scanning direction on the first and second photosensitive drums 308 and 408 is formed by rotating the first and second photosensitive drums 308 and 408 in the sub-scanning direction for each main scanning exposure.

In the light scanning apparatus 20 according to the present embodiment, the first fθ lens 306 provided in the first scanning optical system 95a and the first fθ lens 406 provided in the second scanning optical system 95b are an optical element formed integrally with each other.

This makes it possible to reduce a size of the light scanning apparatus 20 according to the present embodiment.

Further, the light scanning apparatus 20 according to the present embodiment employs a structure in which the light flux LA having passed through the first incident optical system 85a and the light flux LB having passed through the second incident optical system 85b are obliquely incident on the deflecting surface 2a of the deflecting unit 2 in the sub-scanning cross section.

This makes it possible to further reduce the size of the light scanning apparatus 20 according to the present embodiment.

Tables 5 to 7 show various characteristics of the first and second incident optical systems 85a and 85b and the first and second scanning optical systems 95a and 95b of the light scanning apparatus 20 according to the present embodiment.

TABLE 5
Characteristics of light sources 301 and 401

| | | |
|---|---|---|
| Wavelength | λ (nm) | 790 |
| Incident polarization to deflecting | | p-polarization |
| surface 2a of deflecting unit 2 | | |
| Full angle at half maximum in main | FFPy(deg) | 12.00 |
| scanning direction | | |
| Full angle at half maximum in sub- | FFPz(deg) | 30.00 |
| scanning direction | | |

Shape of stop

| | Main scanning | Sub-scanning |
|---|---|---|
| | direction | direction |
| Sub-scanning stop 303 and 403 | 3.750 | 2.840 |
| Main scanning stop 304 and 404 | 3.750 | 2.840 |

Refractive index

| | | |
|---|---|---|
| Anamorphic collimating lenses 302 and 402 | N1 | 1.5282 |

| | |
|---|---|
| Main scanning | Sub-scanning |
| direction | direction |

Shape of optical elements

| | | | |
|---|---|---|---|
| Curvature radius of | r1a | ∞ | ∞ |
| incident surface of | (mm) | | |
| anamorphic collimating | | | |
| lenses 302 and 402 | | | |
| Curvature radius of exit | r1b | −37.169 | −26.170 |
| surface of anamorphic | (mm) | | |
| collimating lenses 302 | | | |
| and 402 | | | |
| Phase coefficient of | D2, 0 | −7.847E−03 | — |
| incident surface of | | | |
| anamorphic collimating | D0, 2 | — | −8.669E−03 |
| lenses 302 and 402 | | | |

Focal length

| | | | |
|---|---|---|---|
| Anamorphic collimating | fcol | 33.94 | 27.15 |
| lenses 302 and 402 | (mm) | | |

Arrangement

| | | |
|---|---|---|
| From light sources 301 and 401 to incident surface | d0 (mm) | 28.09 |
| of anamorphic collimating lenses 302 and 402 | | |
| From incident surface of anamorphic collimating | d1 (mm) | 5.50 |
| lenses 302 and 402 to exit surface of anamorphic | | |
| collimating lenses 302 and 402 | | |
| From exit surface of anamorphic collimating lenses | d2 (mm) | 3.00 |
| 302 and 402 to sub-scanning stop 303 and 403 | | |
| From sub-scanning stop 303 and 403 to main | d4 (mm) | 15.15 |
| scanning stop 304 and 404 | | |
| From main scanning stop 304 and 404 to deflecting | d5 (mm) | 80.09 |
| surface 2a of deflecting unit 2 | | |
| Incident angle of light flux LA that has passed | A1 (deg) | 78.00 |
| through main scanning stop 304 on deflecting | | |
| surface 2a in main scanning cross section | | |
| Incident angle of light flux LB that has passed | A2 (deg) | 78.00 |
| through main scanning stop 404 on deflecting | | |
| surface 2a in main scanning cross section | | |
| Incident angle of light flux LA that has passed | A3 (deg) | −2.76 |
| through main scanning stop 304 on deflecting | | |
| surface 2a in sub-scanning cross section | | |
| Incident angle of light flux LB that has passed | A4 (deg) | 2.76 |
| through main scanning stop 404 on deflecting | | |
| surface 2a in sub-scanning cross section | | |

TABLE 6
fθ-coefficient, Scanning width, Maximum angle of view

| | | |
|---|---|---|
| fθ-coefficient | k(mm/rad) | 207 |
| Scanning width | W(mm) | 330 |
| Maximum angle of view | θ(deg) | 45.7 |

Refractive index

| | | |
|---|---|---|
| Refractive index of first fθ lens 306 | N5 | 1.5282 |
| Refractive index of second fθ lens 307 | N6 | 1.5282 |

Deflecting unit 2

| | | |
|---|---|---|
| Number of deflecting surfaces | | 4 |
| Radius of circumscribed circle | Rpol(mm) | 10 |
| From rotation center to deflection | Xpol(mm) | 5.74 |
| reference point C0 (optical axis direction) | | |
| From rotation center to deflection | Ypol(mm) | 4.26 |
| reference point C0 (main scanning direction) | | |

Arrangement of scanning optical system 95a

| | | |
|---|---|---|
| From deflection reference point C0 to | d12 (mm) | 26.00 |
| incident surface of first fθ lens 306 | | |
| From incident surface of first fθ lens | d13 (mm) | 8.20 |
| 306 to exit surface of first fθ lens 306 | | |
| From exit surface of first fθ lens 306 | d14 (mm) | 87.80 |
| to incident surface of second fθlens 307 | | |
| From incident surface of second fθ lens | d15 (mm) | 4.30 |
| 307 to exit surface of second fθ lens 307 | | |
| From exit surface of second fθ lens 307 | d16 (mm) | 106.70 |
| to first scanned surface 308 | | |
| From deflection reference point C0 to | L1(mm) | 26.00 |
| incident surface of first fθ lens 306 | | |
| From deflection reference point C0 to | L2(mm) | 122.00 |
| incident surface of second fθ lens 307 | | |
| From deflection reference point C0 to | T2(mm) | 233.00 |
| first scanned surface 308 | | |
| Sub-scanning eccentricity of first fθ lens 307 | shiftZ(mm) | 7.21 |

Meridional line shape of first fθ lens 306

| | Incident surface | Exit surface |
|---|---|---|
| | Opposite light source side | Opposite light source side |
| R | −71.101 | −43.800 |
| ku | 9.464E−01 | −9.321E−01 |
| B4u | −9.147E−07 | −1.355E−06 |
| B6u | 6.784E−09 | 1.719E−09 |
| B8u | −5.767E−12 | 8.761E−13 |
| B10u | 1.638E−15 | −1.069E−15 |
| B12u | 0 | 0 |

| | Light source side | Light source side |
|---|---|---|
| kl | 9.464E−01 | −9.321E−01 |
| B4l | −9.147E−07 | −1.355E−06 |
| B6l | 6.784E−09 | 1.719E−09 |
| B8l | −5.767E−12 | 8.761E−13 |
| B10l | 1.638E−15 | −1.069E−15 |
| B12l | 0 | 0 |

Sagittal line shape of first fθ lens 306

| | Incident surface | Exit surface |
|---|---|---|
| | Change of R of sagittal line | Change of R of sagittal line |
| r | 20.000 | 55.261 |
| E1 | 0 | 0 |
| E2 | 0 | 6.894E−06 |
| E3 | 0 | 0 |
| E4 | 0 | 8.425E−08 |
| E5 | 0 | 0 |
| E6 | 0 | −2.679E−10 |
| E7 | 0 | 0 |
| E8 | 0 | 3.4364E−13 |
| E9 | 0 | 0 |
| E10 | 0 | −1.53852E−16 |

| | Sagittal line tilt | Sagittal line tilt |
|---|---|---|
| M0_1 | 0 | 7.661E−02 |
| M1_1 | 0 | 0.000E+00 |
| M2_1 | 0 | −3.906E−05 |
| M3_1 | 0 | 0.000E+00 |
| M4_1 | 0 | 0.000E+00 |
| M5_1 | 0 | 0 |
| M6_1 | 0 | 0 |
| M7_1 | 0 | 0 |
| M8_1 | 0 | 0 |
| M9_1 | 0 | 0 |
| M10_1 | 0 | 0 |
| M11_1 | 0 | 0 |
| M12_1 | 0 | 0 |

Meridional line shape of second fθ lens 307

| | Incident surface | Exit surface |
|---|---|---|
| | Opposite light source side | Opposite light source side |
| R | −4000 | 379.967 |
| ku | 0 | −7.412E+01 |
| B4u | 0 | −1.332E−07 |
| B6u | 0 | 7.206E−12 |
| B8u | 0 | −3.070E−16 |
| B10u | 0 | 6.089E−21 |
| B12u | 0 | 0.000E+00 |

| | Light source side | Light source side |
|---|---|---|
| kl | 0 | −7.412E+01 |
| B4l | 0 | −1.332E−07 |
| B6l | 0 | 7.206E−12 |
| B8l | 0 | −3.070E−16 |
| B10l | 0 | 6.089E−21 |
| B12l | 0 | 0.000E+00 |

Sagittal line shape of second fθ lens 307

| | Incident surface | Exit surface |
|---|---|---|
| | Change of R of sagittal line | Change of R of sagittal line |
| r | 37.426 | −249.9931 |
| E1 | 0.000E+00 | 9.40981E−09 |
| E2 | −3.482E−07 | 1.44641E−06 |
| E3 | 0 | −1.61579E−09 |
| E4 | 0.000E+00 | −2.7926E−10 |
| E5 | 0 | 4.72069E−13 |
| E6 | 0.000E+00 | 4.45476E−14 |
| E7 | 0 | −5.35403E−17 |
| E8 | 0.000E+00 | −3.93574E−18 |
| E9 | 0 | 2.02748E−21 |
| E10 | 0 | 1.36304E−22 |

| | Sagittal line tilt | Sagittal line tilt |
|---|---|---|
| M0_1 | 1.211E−01 | −5.801E−02 |
| M1_1 | 2.129E−04 | 2.002E−04 |
| M2_1 | 1.111E−05 | 2.292E−05 |
| M3_1 | −1.419E−07 | −1.288E−07 |
| M4_1 | −5.557E−10 | −2.627E−09 |
| M5_1 | 2.589E−11 | 2.174E−11 |
| M6_1 | −2.459E−13 | 2.067E−13 |
| M7_1 | −2.150E−15 | −1.675E−15 |
| M8_1 | 1.182E−17 | −3.209E−17 |
| M9_1 | 6.130E−20 | 4.199E−20 |
| M10_1 | 9.717E−23 | 1.487E−21 |
| M11_1 | 0 | 0 |
| M12_1 | 0 | 0 |

TABLE 7
fθ-coefficient, Scanning width, Maximum angle of view

| | | |
|---|---|---|
| fθ-coefficient | k(mm/rad) | 207 |
| Scanning width | W(mm) | 330 |
| Maximum angle of view | θ(deg) | 45.7 |

Refractive index

| | | |
|---|---|---|
| Refractive index of first fθ lens 406 | N5 | 1.5282 |
| Refractive index of second fθ lens 407 | N6 | 1.5282 |

Deflecting unit 2

| | | |
|---|---|---|
| Number of deflecting surfaces | | 4 |
| Radius of circumscribed circle | Rpol(mm) | 10 |
| From rotation center to deflection reference | Xpol(mm) | 6.03 |
| point C0 (optical axis direction) | | |
| From rotation center to deflection reference | Ypol(mm) | 3.79 |
| point C0 (main scanning direction) | | |

Arrangement of scanning optical system 95b

| | | |
|---|---|---|
| From deflection reference point C0 to incident | d12 (mm) | 26.00 |
| surface of first fθ lens 406 | | |
| From incident surface of first fθ lens 406 to | d13 (mm) | 8.20 |
| exit surface of first fθ lens 406 | | |
| From exit surface of first fθ lens 406 to | d14 (mm) | 69.30 |
| incident surface of second fθ lens 407 | | |
| From incident surface of second fθ lens 407 | d15 (mm) | 4.30 |
| to exit surface of second fθ lens 407 | | |
| From exit surface of second fθ lens 407 to | d16 (mm) | 125.20 |
| second scanned surface 408 | | |
| From deflection reference point C0 to incident | L3(mm) | 26.00 |
| surface of first fθ lens 406 | | |
| From deflection reference point C0 to incident | L4(mm) | 103.50 |
| surface of second fθ lens 407 | | |
| From deflection reference point C0 to second | T2(mm) | 233.00 |
| scanned surface 408 | | |
| Sub-scanning eccentricity of second fθ lens 407 | shiftZ(mm) | 5.03 |

Meridional line shape of first fθ lens 406

| | Incident surface | Exit surface |
|---|---|---|
| | Opposite light source side | Opposite light source side |
| R | −71.101 | −42.946 |
| ku | 9.464E−01 | −5.155E−01 |
| B4u | −9.147E−07 | −3.477E−07 |
| B6u | 6.784E−09 | 1.690E−09 |
| B8u | −5.767E−12 | 1.110E−12 |
| B10u | 1.638E−15 | −1.224E−15 |
| B12u | 0 | 0 |

| | Light source side | Light source side |
|---|---|---|
| kl | 9.464E−01 | −5.155E−01 |
| B4l | −9.147E−07 | −3.477E−07 |
| B6l | 6.784E−09 | 1.690E−09 |
| B8l | −5.767E−12 | 1.110E−12 |
| B10l | 1.638E−15 | −1.224E−15 |
| B12l | 0 | 0 |

Sagittal line shape of first fθ lens 406

| | Incident surface | Exit surface |
|---|---|---|
| | Change of R of sagittal line | Change of R of sagittal line |
| r | 20.000 | 25.004 |
| E1 | 0 | 0 |
| E2 | 0 | 1.522E−05 |
| E3 | 0 | 0 |
| E4 | 0 | 8.486E−10 |
| E5 | 0 | 0 |
| E6 | 0 | −2.508E−11 |
| E7 | 0 | 0 |
| E8 | 0 | 7.60678E−15 |
| E9 | 0 | 0 |
| E10 | 0 | 1.60971E−17 |

| | Sagittal line tilt | Sagittal line tilt |
|---|---|---|
| M0_1 | 0 | 2.124E−02 |
| M1_1 | 0 | 0 |
| M2_1 | 0 | −3.321E−05 |
| M3_1 | 0 | 0 |
| M4_1 | 0 | 0 |
| M5_1 | 0 | 0 |
| M6_1 | 0 | 0 |
| M7_1 | 0 | 0 |
| M8_1 | 0 | 0 |
| M9_1 | 0 | 0 |
| M10_1 | 0 | 0 |
| M11_1 | 0 | 0 |
| M12_1 | 0 | 0 |

Meridional line shape of second fθ lens 407

| | Incident surface | Exit surface |
|---|---|---|
| | Opposite light source side | Opposite light source side |
| R | −4000 | 350.123 |
| ku | 0 | −8.753E+01 |
| B4u | 0 | −2.020E−07 |
| B6u | 0 | 1.609E−11 |
| B8u | 0 | −9.313E−16 |
| B10u | 0 | 2.524E−20 |
| B12u | 0 | 0 |

| | Light source side | Light source side |
|---|---|---|
| kl | 0 | −8.753E+01 |
| B4l | 0 | −2.020E−07 |
| B6l | 0 | 1.609E−11 |
| B8l | 0 | −9.313E−16 |
| B10l | 0 | 2.524E−20 |
| B12l | 0 | 0 |

Sagittal line shape of second fθ lens 407

| | Incident surface | Exit surface |
|---|---|---|
| | Change of R of sagittal line | Change of R of sagittal line |
| r | 37.079 | −154.0078 |
| E1 | 0 | −1.27778E−07 |
| E2 | −7.458E−07 | 1.81313E−06 |
| E3 | 0 | −3.2397E−09 |
| E4 | 0 | −3.04103E−10 |
| E5 | 0 | 1.33875E−12 |
| E6 | 0 | 3.08183E−14 |
| E7 | 0 | −2.00884E−16 |
| E8 | 0 | −1.95419E−18 |
| E9 | 0 | 9.85865E−21 |
| E10 | 0 | 5.81192E−23 |

| | Sagittal line tilt | Sagittal line tilt |
|---|---|---|
| M0_1 | −1.007E−01 | 2.315E−02 |
| M1_1 | −2.129E−04 | −2.002E−04 |
| M2_1 | −1.314E−05 | −2.370E−05 |
| M3_1 | 1.161E−07 | 1.056E−07 |
| M4_1 | 1.765E−09 | 3.675E−09 |
| M5_1 | −1.616E−11 | −1.409E−11 |
| M6_1 | 3.014E−13 | −3.052E−13 |
| M7_1 | 1.061E−15 | 9.733E−16 |
| M8_1 | −1.306E−17 | 6.574E−17 |
| M9_1 | −1.657E−20 | −1.728E−20 |
| M10_1 | −8.536E−22 | −3.960E−21 |
| M11_1 | 0 | 0 |
| M12_1 | 0 | 0 |

Here, an optical axis direction, an axis orthogonal to the optical axis in the main scanning cross section, and an axis orthogonal to the optical axis in the sub-scanning cross section when an intersecting point of each lens surface and the optical axis is set as an origin are defined as an X axis, a Y axis and a Z axis, respectively. Further, “E-x” means “×10^{-x}” in Tables 6 and 7.

The aspherical surface shape (a meridional line shape) in the main scanning cross section of each lens surface of the first fθ lenses 306 and 406 and the second fθ lenses 307 and 407 provided in the light scanning apparatus 20 according to the present embodiment is expressed by the expression (1) described above.

The aspherical surface shape (a sagittal line shape) in the sub-scanning cross section of each lens surface of the first fθ lenses 306 and 406 and the second fθ lenses 307 and 407 is expressed by the expression (2) described above.

Further, the curvature radius r′ of each lens surface of the first fθ lenses 306 and 406 and the second fθ lenses 307 and 407 in the sub-scanning cross section continuously changes according to the y coordinate of the lens surface as in the following expression (7):

$${r}^{′} = \frac{1}{\frac{1}{r} + {\sum }_{i = 1}^{10} {E}_{i} {Y}^{i}} . \qquad ( 7 )$$

In the expression (7), r represents the curvature radius on the optical axis, and Ei (i=1 to 10) is a variation coefficient.

Furthermore, each of the first and second anamorphic collimating lenses 302 and 402 has an incident surface formed by a diffraction surface expressed by an optical path difference function of two variables Y and Z as shown in the following expression (8):

$$φ ( Y , Z ) = \frac{2 π}{λ} {\sum }_{i = 0 , j = 0} {D}_{i , j} {Y}^{i} {Z}^{j} . \qquad ( 8 )$$

In the expression (8), λ represents a pitch of a diffraction grating, and D_{i,j} represents a phase coefficient.

Next, effects of the light scanning apparatus 20 according to the present embodiment are described.

As shown in FIG. 4B, reflecting mirrors 309 and 310 (first reflecting elements) are provided on the optical path of the light flux LA deflected by the deflecting unit 2, and a reflecting mirror 409 (a second reflecting element) is provided on the optical path of the light flux LB deflected by the deflecting unit 2.

As the reflecting mirrors 309, 310 and 409, a reflecting element or the like on which a vapor deposition film is formed is used.

The light flux LA that has passed through the first fθ lens 306 provided in the first scanning optical system 95a is reflected by the reflecting mirror 309, and then is incident on the second fθ lens 307. The light flux LA that has passed through the second fθ lens 307 is reflected by the reflecting mirror 310, and is guided to the first scanned surface 308.

The light flux LB that has passed through the second fθ lens 407 provided in the second scanning optical system 95b is reflected by the reflecting mirror 409, and is guided to the second scanned surface 408.

Here, it is considered to reduce a distance between the first and second photosensitive drums 308 and 408 corresponding to the first and second scanned surfaces 308 and 408 in order to downsize an image forming apparatus on which the light scanning apparatus 20 according to the present embodiment is mounted.

At this time, in the light scanning apparatus 20 according to the present embodiment, if the second fθ lens 307 and the second fθ lens 407 are arranged at positions away from the deflecting unit 2 by a distance optically equivalent to each other, an unnecessary interference of the light flux with the second fθ lens may occur.

Specifically, the light flux LA may be incident on the second fθ lens 407 provided in the second scanning optical system 95b, or the light flux LB may be incident on the second fθ lens 307 provided in the first scanning optical system 95a.

Accordingly, in the light scanning apparatus 20 according to the present embodiment, the second fθ lens 307 and the second fθ lens 407 are arranged at positions away from the deflecting unit 2 by a distance optically non-equivalent to each other. Specifically, the second fθ lens 407 is arranged at a position closer to the deflecting unit 2 than the second fθ lens 307 on an optical path.

This can reduce the distance between the first and second photosensitive drums 308 and 408 with suppressing the unnecessary interference of the light flux with the second fθ lens to achieve a reduction in the size of the image forming apparatus on which the light scanning apparatus 20 according to the present embodiment is mounted.

Table 8 shows various characteristics of the first fθ lenses 306 and 406 and the second fθ lenses 307 and 407 provided in the light scanning apparatus 20 according to the present embodiment.

TABLE 8

| | Incident surface | Exit surface | Entire system |
|---|---|---|---|
| | First fθ lens 306 | | |
| Refractive Index | 1.5282 | | |
| Thickness | 8.2 | | |
| Curvature radius | 20 | 55.261 | — |
| Refractive power | 0.0264 | −0.0096 | 0.0182 |
| Tilt amount (M0_1) | 0 | 0.0766 | — |
| Focal length | 37.865 | −104.623 | 54.927 |
| | First fθ lens 406 | | |
| Refractive Index | 1.5282 | | |
| Thickness | 8.2 | | |
| Curvature radius | 20 | 25.004 | — |
| Refractive power | 0.0264 | −0.0211 | 0.0083 |
| Tilt amount (M0_1) | 0 | 0.0810 | — |
| Focal length | 37.865 | −47.339 | 120.790 |
| | Second fθ lens 307 | | |
| Refractive Index | 1.5282 | | |
| Thickness | 4.3 | | |
| Curvature radius | 37.426 | −249.993 | — |
| Refractive power | 0.0141 | 0.0021 | 0.0161 |
| Tilt amount (M0_1) | 0.1211 | −0.0580 | — |
| Focal length | 70.857 | 473.300 | 61.951 |
| | Second fθ lens 407 | | |
| Refractive Index | 1.5282 | | |
| Thickness | 4.3 | | |
| Curvature radius | 37.079 | −154.008 | — |
| Refractive power | 0.0142 | 0.0034 | 0.0175 |
| Tilt amount (M0_1) | 0 | 0.0810 | — |
| Focal length | 70.200 | 291.576 | 57.022 |

Here, refractive powers in the sub-scanning cross section of the first and second fθ lenses 306 and 307 are represented by ϕ1 and ϕ2, respectively.

Further, the refractive powers in the sub-scanning cross section of the first and second fθ lenses 406 and 407 are represented by ϕ3 and ϕ4, respectively.

At this time, in the light scanning apparatus 20 according to the present embodiment, ϕ1=0.0182, ϕ2=0.0161 and ϕ3=0.0083 as shown in Table 8, so that the above-described inequalities (4) and (5) are satisfied.

Thereby, the first and second scanning optical systems 95a and 95b can adopt the optical arrangement as shown in FIG. 4B, and the light scanning apparatus 20 according to the present embodiment and the image forming apparatus on which the light scanning apparatus 20 according to the present embodiment is mounted can be downsized.

Next, it is considered that sub-scanning magnifications of the first scanning optical system 95a and the second scanning optical system 95b are made substantially equal to each other.

At this time, when the second fθ lens 307 and the second fθ lens 407 are arranged at positions away from the deflecting unit 2 by a distance optically non-equivalent to each other, it is required that the refractive powers in the sub-scanning cross section of the first fθ lenses 306 and 406 are made different from each other.

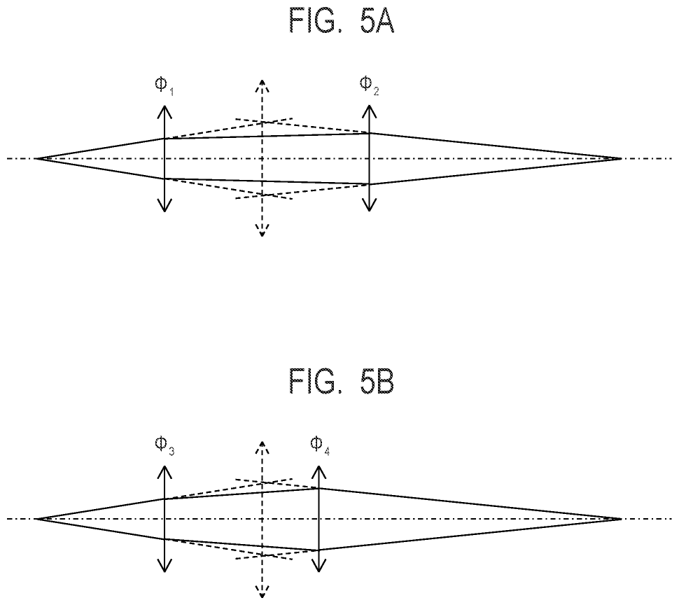

FIG. 5A shows a refractive power arrangement in the sub-scanning cross section of the first scanning optical system 95a in the light scanning apparatus 20 according to the present embodiment.

Further, FIG. 5B shows the refractive power arrangement in the sub-scanning cross section of the second scanning optical system 95b in the light scanning apparatus 20 according to the present embodiment.

Here, in the light scanning apparatus 20 according to the present embodiment, the following inequality (9) is satisfied:

ϕ1>ϕ3 (9).

In the light scanning apparatus 20 according to the present embodiment, ϕ1=0.0182 and ϕ3=0.0083 as shown in Table 8, so that the inequality (9) is satisfied.

Further, in the light scanning apparatus 20 according to the present embodiment, ϕ3=0.0083 and ϕ4=0.0175 as shown in Table 8, so that the above-described inequality (6) is satisfied.

As described above, the refractive power in the sub-scanning cross section of each fθ lens is set such that the inequalities (4), (6) and (9) are satisfied in the light scanning apparatus 20 according to the present embodiment.

Thereby, as shown in FIGS. 5A and 5B, the refractive power combined in the entire first scanning optical system 95a and that combined in the entire second scanning optical system 95b can be made substantially equal to each other.

Then, the sub-scanning magnifications of the first scanning optical system 95a and the second scanning optical system 95b are 1.45 and 1.46, respectively, namely the sub-scanning magnifications can be made substantially equal to each other in the first scanning optical system 95a and the second scanning optical system 95b.

Here, distances between the on-axis deflection point C0, and the first fθ lens 306 and the second fθ lens 307 provided in the first scanning optical system 95a are represented by L1 and L2, respectively.

Further, the distances between the on-axis deflection point C0, and the first fθ lens 406 and the second fθ lens 407 provided in the second scanning optical system 95b are represented by L3 and L4, respectively.

At this time, in the light scanning apparatus 20 according to the present embodiment, the following conditional expression (10) is satisfied:

L2/L4>L3/L1 (10).

In the light scanning apparatus 20 according to the present embodiment, L1=26.00 mm, L2=122.00 mm, L3=26.00 mm and L4=103.50 mm as shown in Tables 6 and 7, so that the inequality (10) is satisfied.

This makes it easy to make the sub-scanning magnifications of the first scanning optical system 95a and the second scanning optical system 95b substantially equal to each other.

Further, in the light scanning apparatus 20 according to the present embodiment, the values of ϕ1, ϕ2, ϕ3 and ϕ4 are all positive as shown in Table 8.

This makes it possible to reduce the refractive power in the sub-scanning cross section of each of the first fθ lenses 306 and 406 and the second fθ lenses 307 and 407.

As described above, in the light scanning apparatus 20 according to the present embodiment, it is possible to achieve a sufficient reduction in size by forming the first and second scanning optical systems 95a and 95b such that the inequalities (4) and (5) are satisfied.

Further, in the light scanning apparatus 20 according to the present embodiment, the sub-scanning magnifications in the first and second scanning optical systems 95a and 95b can be made substantially equal to each other by setting the refractive power in the sub-scanning cross section of each fθ lens such that the inequalities (4), (6) and (9) are satisfied.

### Third Embodiment

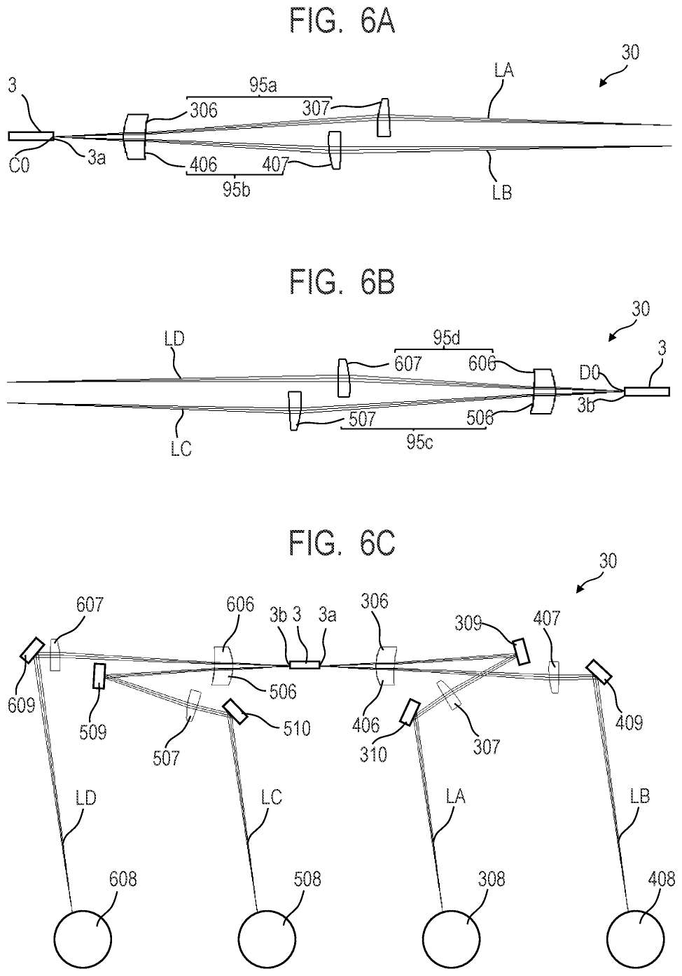

FIG. 6A shows a developed view in the sub-scanning cross section of first and second scanning optical systems 95a and 95b included in a light scanning apparatus 30 according to a third embodiment of the present invention.

Further, FIG. 6B shows a developed view in a sub-scanning cross section of third and fourth scanning optical systems 95c and 95d included in the light scanning apparatus 30 according to the present embodiment.

Furthermore, FIG. 6C shows a sub-scanning cross sectional view of the first to fourth scanning optical systems 95a to 95d included in the light scanning apparatus 30 according to the present embodiment.

The light scanning apparatus 30 according to the present embodiment has the same structure as that of the light scanning apparatus 20 according to the second embodiment except that the third and fourth scanning optical systems 95c and 95d are newly provided, so that the same members are denoted by the same numerals and the description thereof is omitted.

The light scanning apparatus 30 according to the present embodiment includes a deflecting unit 3 and first fθ lenses 306, 406, 506 and 606.

Further, the light scanning apparatus 30 according to the present embodiment includes second fθ lenses 307, 407, 507 and 607.

The second fθ lens 307 (a second imaging optical element) is arranged between the first fθ lens 306 (a first imaging optical element) and the first scanned surface 308 on an optical path. The second fθ lens 407 (a fourth imaging optical element) is arranged between the first fθ lens 406 (a third imaging optical element) and the second scanned surface 408 on an optical path.

The second fθ lens 507 (a sixth imaging optical element) is arranged between the first fθ lens 506 (a fifth imaging optical element) and the third scanned surface 508 on an optical path. The second fθ lens 607 (an eighth imaging optical element) is arranged between the first fθ lens 606 (a seventh imaging optical element) and the fourth scanned surface 608 on an optical path.

The deflecting unit 3 is rotated by a driving unit such as a motor (not shown) to deflect the incident light fluxes LA, LB, LC and LD. The deflecting unit 3 is formed by a polygon mirror, for example.

The first fθ lens 306 and the second fθ lens 307 are anamorphic imaging lenses having different refractive powers between the main scanning cross section and the sub-scanning cross section, and condense (guide) the light flux LA deflected by a first deflecting surface 3a of the deflecting unit 3 onto the first scanned surface 308.

The first fθ lens 406 and the second fθ lens 407 are anamorphic imaging lenses having different refractive powers between the main scanning cross section and the sub-scanning cross section, and condense (guide) the light flux LB deflected by the first deflecting surface 3a of the deflecting unit 3 onto the second scanned surface 408.

The first fθ lens 506 and the second fθ lens 507 are anamorphic imaging lenses having different refractive powers between the main scanning cross section and the sub-scanning cross section, and condense (guide) the light flux LC deflected by a second deflecting surface 3b of the deflecting unit 3 onto the third scanned surface 508.

The first fθ lens 606 and the second fθ lens 607 are anamorphic imaging lenses having different refractive powers between the main scanning cross section and the sub-scanning cross section, and condense (guide) the light flux LD deflected by the second deflecting surface 3b of the deflecting unit 3 onto the fourth scanned surface 608.

In the light scanning apparatus 30 according to the present embodiment, the first fθ lens 306 and the second fθ lens 307 form a first scanning optical system 95a (a first imaging optical system). The first fθ lens 406 and the second fθ lens 407 form a second scanning optical system 95b (a second imaging optical system).

Further, in the light scanning apparatus 30 according to the present embodiment, the first fθ lens 506 and the second fθ lens 507 form a third scanning optical system 95c (a third imaging optical system). The first fθ lens 606 and the second fθ lens 607 form a fourth scanning optical system 95d (a fourth imaging optical system).

Note that refractive powers in the sub-scanning cross section of the second ID lenses 307 and 407 are stronger than those of the first fθ lenses 306 and 406, namely the strongest in the first and second scanning optical systems 95a and 95b, respectively.

Further, the refractive powers in the sub-scanning cross section of the second ID lenses 507 and 607 are stronger than those of the first fθ lenses 506 and 606, namely the strongest in the third and fourth scanning optical systems 95c and 95d, respectively.

The light flux LA (a first light flux) incident on the first deflecting surface 3a of the deflecting unit 3 from an incident optical system (a first incident optical system) (not shown) is deflected for scanning by the deflecting unit 3. Thereafter, the light flux LA is condensed onto the first scanned surface 308 by the first scanning optical system 95a, to scan the first scanned surface 308 at a constant speed.

The light flux LB (a second light flux) incident on the first deflecting surface 3a of the deflecting unit 3 from an incident optical system (a second incident optical system) (not shown) is deflected for scanning by the deflecting unit 3. Thereafter, the light flux LB is condensed onto the second scanned surface 408 by the second scanning optical system 95b to scan the second scanned surface 408 at a constant speed.

The light flux LC (a third light flux) incident on the second deflecting surface 3b of the deflecting unit 3 from an incident optical system (a third incident optical system) (not shown) is deflected for scanning by the deflecting unit 3. Thereafter, the light flux LC is condensed onto the third scanned surface 508 by the third scanning optical system 95c, to scan the third scanned surface 508 at a constant speed.

The light flux LD (a fourth light flux) incident on the second deflecting surface 3b of the deflecting unit 3 from an incident optical system (a fourth incident optical system) (not shown) is deflected for scanning by the deflecting unit 3. Thereafter, the light flux LD is condensed onto the fourth scanned surface 608 by the fourth scanning optical system 95d to scan the fourth scanned surface 608 at a constant speed.

Here, C0 is a deflection point (an on-axis deflection point) on the first deflecting surface 3a of the deflecting unit 3 with respect to principal rays of on-axis light fluxes of the light fluxes LB and LB, and is a reference point (a deflection reference point) of the first and second scanning optical systems 95a and 95b.

Further, D0 is the deflection point (the on-axis deflection point) on the second deflecting surface 3b of the deflecting unit 3 with respect to the principal rays of the on-axis light fluxes of the light fluxes LC and LD, and is the reference point (the deflection reference point) of the third and fourth scanning optical systems 95c and 95d.

In the present embodiment, first, second, third and fourth photosensitive drums 308, 408, 508 and 608 are used as the first, second, third and fourth scanned surfaces 308, 408, 508 and 608.

An exposure distribution in the sub-scanning direction on the first to fourth photosensitive drums 308 to 608 is formed by rotating the first to fourth photosensitive drums 308 to 608 in the sub-scanning direction for each main scanning exposure.

In the light scanning apparatus 30 according to the present embodiment, the first fθ lens 306 provided in the first scanning optical system 95a and the first fθ lens 406 provided in the second scanning optical system 95b are an optical element formed integrally with each other.

Similarly, the third fθ lens 506 provided in the third scanning optical system 95c and the fourth fθ lens 606 provided in the fourth scanning optical system 95d are an optical element formed integrally with each other.

This makes it possible to reduce a size of the light scanning apparatus 30 according to the present embodiment.

Further, the light scanning apparatus 30 according to the present embodiment employs a structure in which the light fluxes LA and LB having passed through the incident optical systems (not shown) are obliquely incident on the first deflecting surface 3a of the deflecting unit 3 in the sub-scanning cross section.

Similarly, the light scanning apparatus 30 according to the present embodiment employs the structure in which the light fluxes LC and LD having passed through the incident optical systems (not shown) are obliquely incident on the second deflecting surface 3b of the deflecting unit 3 in the sub-scanning cross section.

This makes it possible to further reduce the size of the light scanning apparatus 30 according to the present embodiment.

As shown in FIG. 6C, reflecting mirrors 309 and 310 (first reflecting elements) are provided on an optical path of the light flux LA deflected by the deflecting unit 3, and a reflecting mirror 409 (a second reflecting element) is provided on the optical path of the light flux LB deflected by the deflecting unit 3.

Further, the reflecting mirrors 509 and 510 are provided on the optical path of the light flux LC deflected by the deflecting unit 3, and the reflecting mirror 609 is provided on the optical path of the light flux LD deflected by the deflecting unit 3.

As the reflecting mirrors 309, 310, 409, 509, 510 and 609, a reflecting element or the like on which a vapor deposition film is formed is used.

The light flux LA that has passed through the first fθ lens 306 provided in the first scanning optical system 95a is reflected by the reflecting mirror 309, and then is incident on the second fθ lens 307. Then, the light flux LA that has passed through the second fθ lens 307 is reflected by the reflecting mirror 310, and is guided to the first scanned surface 308.

The light flux LB that has passed through the second fθ lens 407 provided in the second scanning optical system 95b is reflected by the reflecting mirror 409, and is guided to the second scanned surface 408.

The light flux LC that has passed through the first fθ lens 506 provided in the third scanning optical system 95c is reflected by the reflecting mirror 509, and then is incident on the second fθ lens 507. The light flux LC that has passed through the second fθ lens 507 is reflected by the reflecting mirror 510, and is guided to the third scanned surface 508.

The light flux LD that has passed through the second fθ lens 607 provided in the second scanning optical system 95d is reflected by the reflecting mirror 609, and is guided to the fourth scanned surface 608.

In the first and second scanning optical systems 95a and 95b, refractive powers in the sub-scanning cross section of the first fθ lenses 306 and 406 and the second fθ lens 307 are set such that the inequalities (4) and (5) are satisfied, similarly to the light scanning apparatus 20 according to the second embodiment.

Further, as shown in FIGS. 6A to 6C, optical structures of the first scanning optical system 95a and the third scanning optical system 95c are equivalent to each other, and the optical structures of the second scanning optical system 95b and the fourth scanning optical system 95d are equivalent to each other.

Here, the refractive powers in the sub-scanning cross section of the first and second fθ lenses 506 and 507 provided in the third scanning optical system 95c are represented by ϕ5 and ϕ6, respectively.

The refractive powers in the sub-scanning cross section of the first and second fθ lenses 606 and 607 provided in the fourth scanning optical system 95d are represented by ϕ7 and ϕ8, respectively.

Further, distances between the on-axis deflection point D0, and the first fθ lens 506 and the second fθ lens 507 provided in the third scanning optical system 95c are represented by L5 and L6, respectively.

The distances between the on-axis deflection point D0, and the first fθ lens 606 and the second fθ lens 607 provided in the fourth scanning optical system 95d are represented by L7 and L8, respectively.

At this time, ϕ1=ϕ5, ϕ2=ϕ6, ϕ3=ϕ7 and ϕ4=ϕ8 are satisfied.

Further, L1=L5, L2=L6, L3=L7 and L4=L8 are satisfied.

Also in the third scanning optical system 95c and the fourth scanning optical system 95d, the refractive powers in the sub-scanning cross section of the first fθ lenses 506 and 606 and the second fθ lens 507 are set such that the following inequalities (11) and (12) are satisfied:

ϕ6/ϕ5≤1 (11)

ϕ5≠ϕ7 (12).

Thereby, the first to fourth scanning optical systems 95a to 95d can adopt optical arrangements as shown in FIGS. 6A to 6C, and the light scanning apparatus 30 according to the present embodiment and the image forming apparatus on which the light scanning apparatus 30 according to the present embodiment is mounted can be downsized.

In the first scanning optical system 95a and the second scanning optical system 95b, the refractive power in the sub-scanning cross section of each fθ lens is set such that the inequalities (4), (6) and (9) are satisfied, similarly to the light scanning apparatus 20 according to the second embodiment.

Also in the third scanning optical system 95c and the fourth scanning optical system 95d, the refractive power in the sub-scanning cross section of each fθ lens is set such that the inequality (11) and the following inequalities (13) and (14) are satisfied:

ϕ7≤ϕ8 (13)

ϕ5>ϕ7 (14).

Thereby, the refractive power combined in the entire third scanning optical system 95c and the refractive power combined in the entire fourth scanning optical system 95d can be made substantially equal to each other. Accordingly, sub-scanning magnifications of the third scanning optical system 95c and the fourth scanning optical system 95d can be made substantially equal to each other.

In the light scanning apparatus 30 according to the present embodiment, the following inequality (15) is satisfied:

L6/L8>L7/L5 (15).

This makes it easy to make the sub-scanning magnifications of the third scanning optical system 95c and the fourth scanning optical system 95d substantially equal to each other.

Further, in one embodiment, the values of ϕ5, ϕ6, ϕ7 and ϕ8 are all positive in the light scanning apparatus 30 according to the present embodiment.

This makes it possible to reduce the refractive power in the sub-scanning cross section of each of the first fθ lenses 506 and 606 and the second fθ lenses 507 and 607.

As described above, in the light scanning apparatus 30 according to the present embodiment, it is possible to achieve a sufficient reduction in size by forming the first, second, third and fourth scanning optical systems 95a, 95b, 95c and 95d such that the inequalities (4) and (5) and the inequalities (11) and (12) are satisfied.

Further, in the light scanning apparatus 30 according to the present embodiment, the refractive power in the sub-scanning cross section of each fθ lens is set such that the inequalities (4), (6), (9), (11), (13) and (14) are satisfied. Thereby, the sub-scanning magnifications of the first to fourth scanning optical systems 95a to 95d can be made substantially equal to each other.

According to the invention, a light scanning apparatus which can be sufficiently downsized can be provided.

[Image Forming Apparatus]

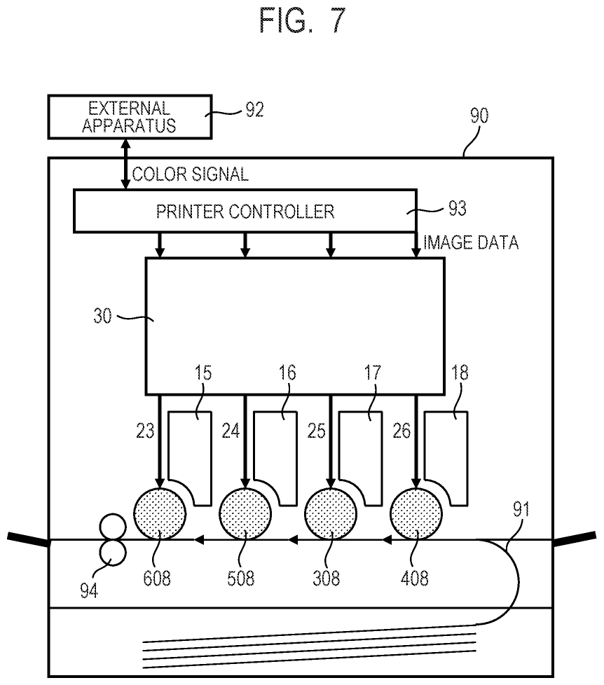

FIG. 7 shows a sub-scanning cross sectional view of a main part of an image forming apparatus 90 in which the light scanning apparatus 30 according to the third embodiment is mounted.

The image forming apparatus 90 is a tandem-type color image forming apparatus that records image information on a surface of each photosensitive drum serving as an image bearing member by using the light scanning apparatus 30 according to the third embodiment.

The image forming apparatus 90 includes the light scanning apparatus 30 according to the third embodiment, photosensitive drums (photosensitive bodies) 308, 408, 508 and 608 as image bearing members, and developing units 15, 16, 17 and 18.

Further, the image forming apparatus 90 includes a conveying belt 91, a printer controller 93 and a fixing unit 94.

Color signals (code data) of R (red), G (green) and B (blue) output from an external apparatus 92 such as a personal computer are input to the image forming apparatus 90.

The input color signals are converted into image data (dot data) of C (cyan), M (magenta), Y (yellow) and K (black) by the printer controller 93 in the image forming apparatus 90.

The converted image data is input to the light scanning apparatus 30. The light beams 23, 24, 25 and 26 modulated in accordance with the image data are emitted from the light scanning apparatus 30, and photosensitive surfaces of the photosensitive drums 608, 508, 308 and 408 are exposed to the light beams 23, 24, 25 and 26.

Charging rollers (not shown) for uniformly charging the surfaces of the photosensitive drums 608, 508, 308 and 408 are provided so as to abut against the surfaces.

The surfaces of the photosensitive drums 608, 508, 308 and 408 charged by the charging rollers are irradiated with the light beams 23, 24, 25 and 26 by the light scanning apparatus 30.

As described above, the light beams 23, 24, 25 and 26 are modulated based on the image data of the respective colors, and electrostatic latent images are formed on the surfaces of the photosensitive drums 608, 508, 308 and 408 by irradiating the surfaces with the light beams 23, 24, 25 and 26.

The formed electrostatic latent images are developed as toner images by developing units 15, 16, 17 and 18 arranged so as to abut on the photosensitive drums 608, 508, 308 and 408, respectively.

The toner images developed by the developing units 15 to 18 are multiply transferred onto a sheet (a transferred material) (not shown) conveyed on the conveying belt 91 by a transferring roller (a transferring unit) (not shown) arranged so as to face the photosensitive drums 308 to 608 to form one full-color image.

The sheet on which the unfixed toner image is transferred as described above is further conveyed to a fixing unit 94 behind (on the left side in FIG. 7) the photosensitive drums 308, 408, 508 and 608.

The fixing unit 94 includes a fixing roller having a fixing heater (not shown) therein, and a pressurizing roller arranged so as to be in pressure contact with the fixing roller.

Then, the conveyed sheet is heated with being pressed at a pressure-contact portion between the fixing roller and the pressurizing roller to fix the unfixed toner image on the sheet.

Further, a sheet discharging roller (not shown) is arranged behind the fixing unit 94, and the sheet discharging roller discharges the fixed sheet to the outside of the image forming apparatus 90.

The image forming apparatus 90 records an image signal (image information) on the photosensitive surfaces of the photosensitive drums 308, 408, 508 and 608 corresponding to the respective colors of C, M, Y and K by using the light scanning apparatus 30 to print a color image at high speed.

As the external apparatus 92, a color image reading apparatus including a CCD sensor may be used, for example. In this case, the color image reading apparatus and the image forming apparatus 90 form a color digital copying machine.

Further, in the image forming apparatus 90, two light scanning apparatuses 10 according to the first embodiment or two light scanning apparatuses 20 according to the second embodiment may be provided instead of the light scanning apparatus 30.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-145123, filed Sep. 13, 2022, which is hereby incorporated by reference herein in its entirety.

What is claimed is:

1. An apparatus comprising:
a deflecting unit configured to deflect a first light flux to scan a first surface in a main scanning direction and a second light flux to scan a second surface in the main scanning direction;
a first optical system configured to guide the first light flux deflected by the deflecting unit to the first surface; and
a second optical system configured to guide the second light flux deflected by the deflecting unit to the second surface,
wherein the first optical system includes a first optical element, and a second optical element arranged between the first optical element and the first surface on an optical path of the first optical system,
wherein the second optical system includes a third optical element, and wherein the following inequalities are satisfied:
ϕ1≠ϕ3
ϕ2/ϕ1≤1
where ϕ1, ϕ2 and ϕ3 represent powers in a sub-scanning cross section of the first, second and third optical elements, respectively.

2. The apparatus according to claim 1, wherein the following inequality is satisfied:
ϕ1>ϕ3.

3. The apparatus according to claim 1,
wherein the second optical system includes a fourth optical element arranged between the third optical element and the second surface on an optical path of the second optical system, and
wherein the following inequality is satisfied:
ϕ3≤ϕ4
where ϕ4 represents a power in the sub-scanning cross section of the fourth optical element.

4. The apparatus according to claim 1,
wherein the second optical system includes a fourth optical element arranged between the third optical element and the second surface on an optical path of the second optical system, and
wherein the following inequality is satisfied:
L2/L4>L3/L1
where L1 and L2 represent distances between an on-axis deflection point of the deflecting unit, and the first and second optical elements on the optical path of the first optical system, respectively, and L3 and L4 represent distances between the on-axis deflection point of the deflecting unit, and the third and fourth optical elements on the optical path of the second optical system, respectively.

5. The apparatus according to claim 1,
wherein the second optical system includes a fourth optical element arranged between the third optical element and the second surface on an optical path of the second optical system, and
wherein all of ϕ1, ϕ2, ϕ3 and ϕ4 have positive values when a power in the sub-scanning cross section of the fourth optical element is represented by ϕ4.

6. The apparatus according to claim 1, wherein the first and third optical elements are an optical element formed integrally with each other.

7. The apparatus according to claim 1, further comprising:
a first incident optical system configured to cause the first light flux to be obliquely incident on a first deflecting surface of the deflecting unit in the sub-scanning cross section; and
a second incident optical system configured to cause the second light flux to be obliquely incident on the first deflecting surface of the deflecting unit in the sub-scanning cross section.

8. The apparatus according to claim 1,
wherein the first optical system is configured to guide the first light flux deflected by a first deflecting surface of the deflecting unit to the first surface, and
wherein the second optical system is configured to guide the second light flux deflected by the first deflecting surface of the deflecting unit to the second surface.

9. The apparatus according to claim 8, further comprising:
a third optical system configured to guide a third light flux deflected by a second deflecting surface of the deflecting unit to a third surface; and
a fourth optical system configured to guide a fourth light flux deflected by the second deflecting surface of the deflecting unit to a fourth surface,
wherein the deflecting unit is configured to deflect the third light flux to scan the third surface in the main scanning direction and the fourth light flux to scan the fourth surface in the main scanning direction,
wherein the third optical system includes a fifth optical element, and a sixth optical element arranged between the fifth optical element and the third surface on an optical path of the third optical system,
wherein the fourth optical system includes a seventh optical element, and
wherein the following inequalities are satisfied:
ϕ5≠ϕ7
ϕ6/ϕ5≤1
where ϕ5, ϕ6 and ϕ7 represent powers in the sub-scanning cross section of the fifth, sixth and seventh optical elements, respectively.

10. The apparatus according to claim 9, wherein the following inequality is satisfied:
ϕ5>ϕ7.

11. The apparatus according to claim 9,
wherein the fourth optical system includes an eighth optical element arranged between the seventh optical element and the fourth surface on an optical path of the fourth optical system, and
wherein the following inequality is satisfied:
ϕ7≤ϕ8
where ϕ8 represents a power in the sub-scanning cross section of the eighth optical element.

12. The apparatus according to claim 9,
wherein the fourth optical system includes an eighth optical element arranged between the seventh optical element and the fourth surface on an optical path of the fourth optical system, and
wherein the following inequality is satisfied:
L6/L8>L7/L5
where L5 and L6 represent distances between an on-axis deflection point of the second deflecting surface, and the fifth and sixth optical elements on the optical path of the third optical system, respectively, and L7 and L8 represent distances between the on-axis deflection point of the second deflecting surface, and the seventh and eighth optical elements on the optical path of the fourth optical system, respectively.

13. The apparatus according to claim 9,
wherein the fourth optical system includes an eighth optical element arranged between the seventh optical element and the fourth surface on an optical path of the fourth optical system, and
wherein all of ϕ5, ϕ6, ϕ7 and ϕ8 have positive values when a power in the sub-scanning cross section of the eighth optical element is represented by ϕ8.

14. The apparatus according to claim 9,
wherein the second optical system includes a fourth optical element arranged between the third optical element and the second surface on an optical path of the second optical system,
wherein the fourth optical system includes an eighth optical element arranged between the seventh optical element and the fourth surface on an optical path of the fourth optical system, and
wherein the following equalities are satisfied:
ϕ1=ϕ5
ϕ2=ϕ6
ϕ3=ϕ7
ϕ4=ϕ8
where ϕ4 and ϕ8 represent powers in the sub-scanning cross section of the fourth and eighth optical elements, respectively.

15. The apparatus according to claim 9,
wherein the second optical system includes a fourth optical element arranged between the third optical element and the second surface on an optical path of the second optical system,
wherein the fourth optical system includes an eighth optical element arranged between the seventh optical element and the fourth surface on an optical path of the fourth optical system, and
wherein the following equalities are satisfied:
L1=L5
L2=L6
L3=L7
L4=L8
where L1 and L2 represent distances between an on-axis deflection point of the first deflecting surface, and the first and second optical elements on the optical path of the first optical system, respectively, L3 and L4 represent distances between the on-axis deflection point of the first deflecting surface, and the third and fourth optical elements on the optical path of the second optical system, respectively, L5 and L6 represent distances between an on-axis deflection point of the second deflecting surface, and the fifth and sixth optical elements on the optical path of the third optical system, respectively, and L7 and L8 represent distances between the on-axis deflection point of the second deflecting surface, and the seventh and eighth optical elements on the optical path of the fourth optical system, respectively.

16. The apparatus according to claim 9, wherein the fifth and seventh optical elements are an optical element formed integrally with each other.

17. The apparatus according to claim 9, further comprising:
a third incident optical system configured to cause the third light flux to be obliquely incident on the second deflecting surface in the sub-scanning cross section; and
a fourth incident optical system configured to cause the fourth light flux to be obliquely incident on the second deflecting surface in the sub-scanning cross section.

18. The apparatus according to claim 1,
wherein the second optical system includes a fourth optical element arranged between the third optical element and the second surface on an optical path of the second optical system, and
wherein the apparatus further comprises a first reflecting element arranged between the second optical element and the first surface on the optical path of the first optical system, and a second reflecting element arranged between the fourth optical element and the second surface on the optical path of the second optical system.

19. An image forming apparatus comprising:
the apparatus according to claim 1;
a developing unit configured to develop electrostatic latent images formed on the first and second surfaces by the apparatus as toner images;
a transferring unit configured to transfer the developed toner images to a transferred material; and
a fixing unit configured to fix the transferred toner images to the transferred material.

20. An image forming apparatus comprising:
the apparatus according to claim 1; and
a controller configured to convert code data output from an external apparatus into an image signal to input the image signal to the apparatus.
